(19) United States
(12) Patent Application Publication
(10) Pub. No.: US 2011/0119638 A1
(43) Pub. Date: May 19, 2011

(54) USER INTERFACE METHODS AND SYSTEMS FOR PROVIDING GESTURING ON PROJECTED IMAGES

(76) Inventor: Babak FORUTANPOUR, Carlsbad, CA (US)

(21) Appl. No.: 12/619,945

(22) Filed: Nov. 17, 2009

(51) Int. Cl. G06F 3/048

(52) U.S. Cl. 715/863

(57) ABSTRACT

Methods and systems enable a user to interact with a computing device by tracing a gesture on a surface with a laser beam. The computing device may be equipped with or coupled to a projector and a digital camera. The projector may project an image generated on the computing device on a projection surface which the camera images. Location and movement of a laser spot on the projection surface may be detected within received camera images. The projected image and the received camera image may be correlated so that the computing device can determine the location of a laser spot within the projected image. Movements of the laser spot may be correlated to predefined laser gestures which may be associated to particular functions that the computing device may implement. The functions may be similar to other user interface functionality. The function results may be displayed and projected.

### FIELD OF THE INVENTION

The present invention relates generally to computer user interface systems and more particularly to user interface systems for accepting gesturing on projected images.

### BACKGROUND

Computing devices have become essential tools for the types of communications and collaborations that enable businesses to function efficiently. Many computer-based tools are available to enabling people to work together on documents and in brainstorming sessions, including Internet-based collaboration tools (e.g., Webex), and shared document authoring tools. One of the oldest but most effective collaboration tools involves projecting images on a wall or screen to support a presentation or to enable those in a room to collectively discuss a document. Overhead projectors have been replaced by projectors coupled to or built into computing devices. However, even projecting images direct from a computer fails to fully exploit the potential for group collaboration because only the operator of the computer can modify the projected image.

### SUMMARY

An aspect of the present invention includes a method for implementing a user interface function in a computing device coupled to a digital camera, including projecting an image generated by the computing device onto a surface, viewing the projected image with the digital camera, detecting locations of a laser spot within a field of view of the digital camera, characterizing movement of the laser spot based on the location of the laser spot with respect to the projected image, identifying a function correlated to the characterized laser spot movement, and implementing the identified function on the computing device. In another aspect the method may further include recognizing the projected image within the field of view of the digital camera, and dividing the recognized digital image into tiles, in which characterizing movement of the laser spot is accomplished based upon movement of the laser spot from one tile to another. In another aspect the method may further include recognizing the projected image within the field of view of the digital camera as a content area, dividing the content area into tiles, and, treating the portion of the field of view of the digital camera outside of the content area as a non-content area, in which characterizing movement of the laser spot is accomplished based upon a tile within the content area that the laser spot enters as it either moves from the non-content area into the content area or from within the content area to the non-content area. In a further aspect, characterizing movement of the laser spot may be based upon whether the laser spot traces a path moving from a non-content area to a content area, moving from a content area to a non-content area, or moving from a non-content area to a content area followed by tracing a pattern in the content area followed by movement to the non-content area. In a further aspect, the method may also include determining a color of the laser spot, in which identifying a function correlated to the characterized laser spot movement includes identifying a function correlated to the laser color and the characterized laser spot movement, or treating laser spots determined to be a first color as inputs to an application and including the inputs in the displayed image in which characterizing movement of the laser spot based on the location of the laser spot with respect to the projected image is accomplished for laser spots determined to be a second color. The method may further include detecting locations of a plurality of laser spots within the field of view of the digital camera, including determining a color of each of the plurality of detected laser spots, determining a priority associated with the determined color of each laser spot, and ignoring laser spots of lower priority, in which characterizing movement of the laser spot is performed for the laser spot with a highest priority. In an aspect of the method, characterizing the laser beam reflection includes assigning a code to the movement of the laser spot. In an aspect of the method, identifying a function associated with the laser beam reflection may be based on the type of application running on the computing device. In an aspect of the method, identifying a function associated with the laser spot may involve performing a table look up function using the characterized movement of the laser spot as a look up value for a data table of laser gestures and correlated functions. In an aspect of the method, identifying a function associated with the laser spot may involve performing a table look up function using the characterized movement of the laser spot and the determined laser color as look up values for a data table of laser gestures, laser colors and correlated functions. In another aspect, the method may also include correlating the projected image and the camera image received from the digital camera so that locations of the detected laser spot can be correlated to locations within the projected image, and determining a portion of the projected image encircled by movement of the laser spot on the surface, in which implementing the identified function on the computing device includes implementing the identified function on the determined portion of the projected image. In an aspect, correlating the projected image to the camera image may include recognizing a known pattern in the projected image during a calibration process or tracking a laser spot during a calibration spot during which a user traces the outlines of the content area. In an aspect of the method, implementing the identified function on the computing device may include detecting a subsequent laser spot within the field of view of the camera and treating a location or movement of the laser spot as an input to the computing device. In an aspect of the method, identifying a function correlated to the characterized laser spot movement may depend upon an application running on the computing device. In an aspect of the method, identifying a function correlated to the characterized laser spot movement may include recognizing a letter traced by the laser spot. In an aspect of the method, identifying a function correlated to the characterized laser spot movement may include identifying a menu of user interface options, and implementing the identified function on the computing device may include displaying the menu of user interface options within the projected image, recognizing laser spot on a menu item box as a menu selection input, and implementing a function associated with the menu selection input. In an aspect, the method may further include communicating the projected image to another computing device via a network.

Another aspect provides a computing device that includes a processor, a display coupled to the processor, and memory coupled to the processor, in which the processor is configured with processor-executable instructions to perform operations of the various aspect methods.

Another aspect provides a computing device that includes means for accomplishing the functions involved in the operations of the various aspect methods.

Another aspect is a computer readable storage medium on which are stored computer-executable instructions which when executed would cause a computer to accomplish the processes involved in the various aspect methods.

### BRIEF DESCRIPTION OF THE DRAWINGS

The accompanying drawings, which are incorporated herein and constitute part of this specification, illustrate exemplary aspects of the invention. Together with the general description given above and the detailed description given below, the drawings serve to explain features of the invention.

FIGS. 1A-1C are system component diagrams of alternative systems suitable for use with the various aspects.

FIG. 2A is a view of a projected image divided into content and non-content camera fields of view according to various aspects.

FIGS. 2B-2D are process flow diagrams of aspect methods for calibrating a received camera image to a projected image.

FIG. 3 is a view of a projected image illustrating laser movements into a camera field of view according to an aspect.

FIG. 4 is a view of a projected image illustrating laser movements out of a camera field of view according to an aspect.

FIG. 5 is an example data structure suitable for use with the various aspects.

FIG. 6 is a view of a projected image illustrating a timer for gesture interactions according to an aspect.

FIG. 7 is a view of a projected image illustrating a laser reflection movement invoking a function menu list based on a gesture according to an aspect.

FIG. 8 is a view of a projected image illustrating a laser reflection movement invoking a function based on a gesture according to an aspect.

FIG. 9 is a view of a projected image illustrating a laser reflection movement invoking a function based on a gesture in the non-content space of the projected image.

FIG. 10 is a view of a camera field of view illustrating laser reflection movement in a shape of a letter according to an aspect.

FIG. 11 is a view of a projected image illustrating laser reflection movements out of the camera field of view according to an aspect.

FIG. 12 is a view of a projected image illustrating laser reflection movements of two independent laser beams into the camera field of view according to an aspect.

FIGS. 13A-13C are process flow diagrams of alternative aspect methods for implementing user interface functionality using laser spot movements on projected images.

FIG. 14 is a component block diagram of an example computing device suitable for use with the various aspects.

FIG. 15 is a component block diagram of another example computing device suitable for use with the various aspects.

FIG. 16 is a circuit block diagram of another example computer suitable for use with the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the terms “personal electronic device,” “computing device” and “portable computing device” refer to any one or all of cellular telephones, personal data assistants (PDAs), palm-top computers, notebook computers, personal computers, wireless electronic mail receivers and cellular telephone receivers (e.g., the Blackberry® and Treo® devices), multimedia Internet enabled cellular telephones (e.g., the Blackberry Storm®), and similar electronic devices that include a programmable processor, memory, and a connected or integral touch surface or other pointing device (e.g., a computer mouse).

The terms “external projection surfaces” or “projection surfaces” are used interchangeably herein to refer to any surface capable of supporting a projected image and which does not have communication or data links to support user interface interactions with the computing device. Examples of external projection surfaces include a blank wall and projection screens.

Today, computing devices are an integral part of communication and collaboration among users. Users employ projectors to project images from their computing device display onto external projection surfaces in order to share information and images with others. For instance, to present to a group of people, users typically project their presentation slides onto projection surfaces, while documents may be edited collaboratively by projecting an image of the text on the wall so everyone can make suggestions while one person types on a computer connected to the projector.

Although it is currently common place to project documents from a computing device onto an external projection surface, such as a wall or a projection screen, users are unable to interact with the projected image except through the user interface of the computing device, such as its mouse and keyboard. While users can interact with the content displayed on a computing device touchscreen by touching the touchscreen and gesturing (e.g., to zoom, cut or select objects), such intuitive interactions are not available for projected images.

There are special external display surfaces, such as the SMART Board™ and Microsoft® Surface™, which allow interactive display of a computing device's display contents. These special devices employ sophisticated technology and are expensive. Also, such devices require that the image be projected only on the device's projections surface, and the devices are too large to be portable. Thus, there is no portable collaboration tool available for use with projected images.

The various aspect methods and systems provide a portable user interface for projected computer images enabling laser pointer gestures traced on the external projection surface. In the various aspects, users can interact with the content displayed on the projection surface by using a laser pointer to trace a gesture which is recorded by a camera coupled to a computing device (e.g., built in or attached to the computer). The computing device is configured with processor-executable instructions to recognize the laser pointer gestures and execute the indicated function on the projected content, such as highlighting, copying, cutting, saving, bringing up the next or previous slide, etc. A set of standard intuitive gestures may be implemented, and additional gestures may be created by users training the computing device to correlate a movement pattern of laser beam reflections to a particular function. In this manner anyone with a laser pointer within view of the projected image can interact with the content as if they were controlling the computer mouse. Further, presenters can be control presentations with simple gestures from a laser pointer, freeing them from their computers and from wireless mouse devices. In an aspect, a computing device may be equipped with both a camera and a projector to provide an integrated collaboration system.

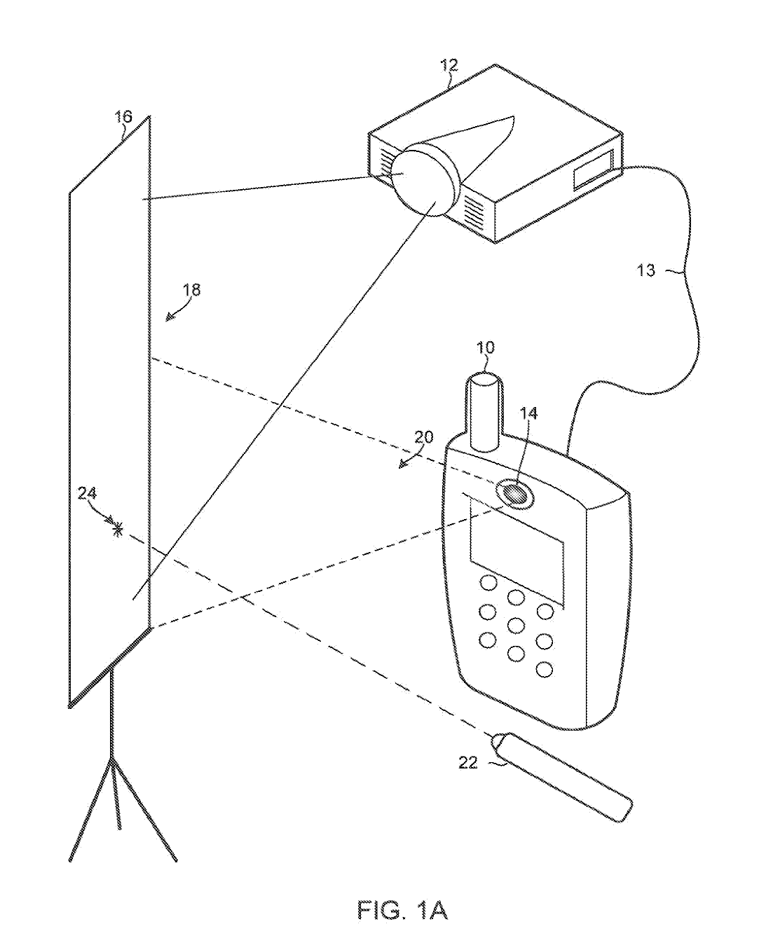

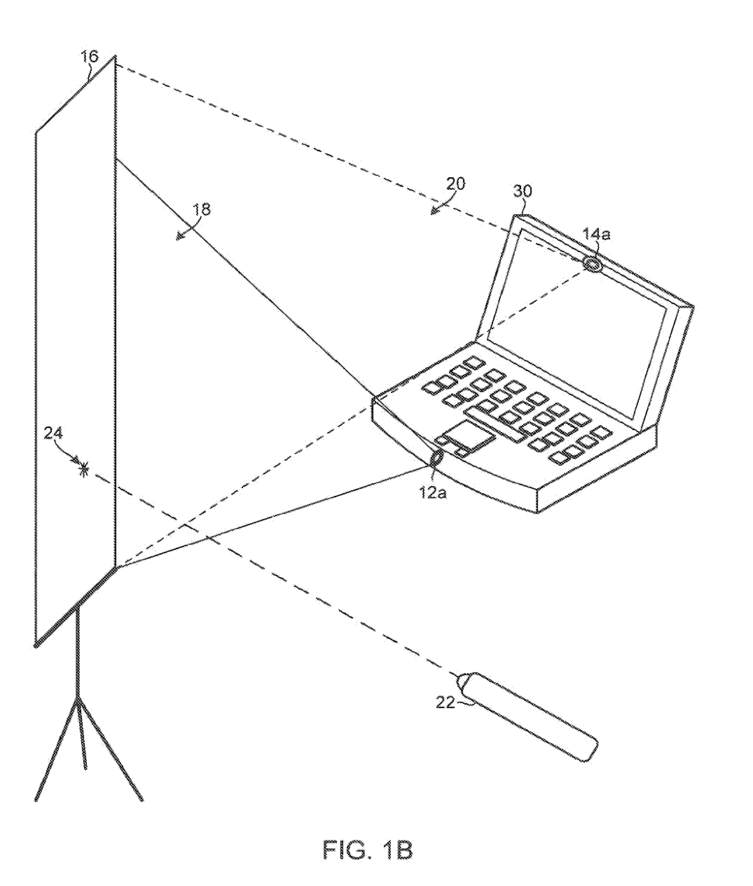

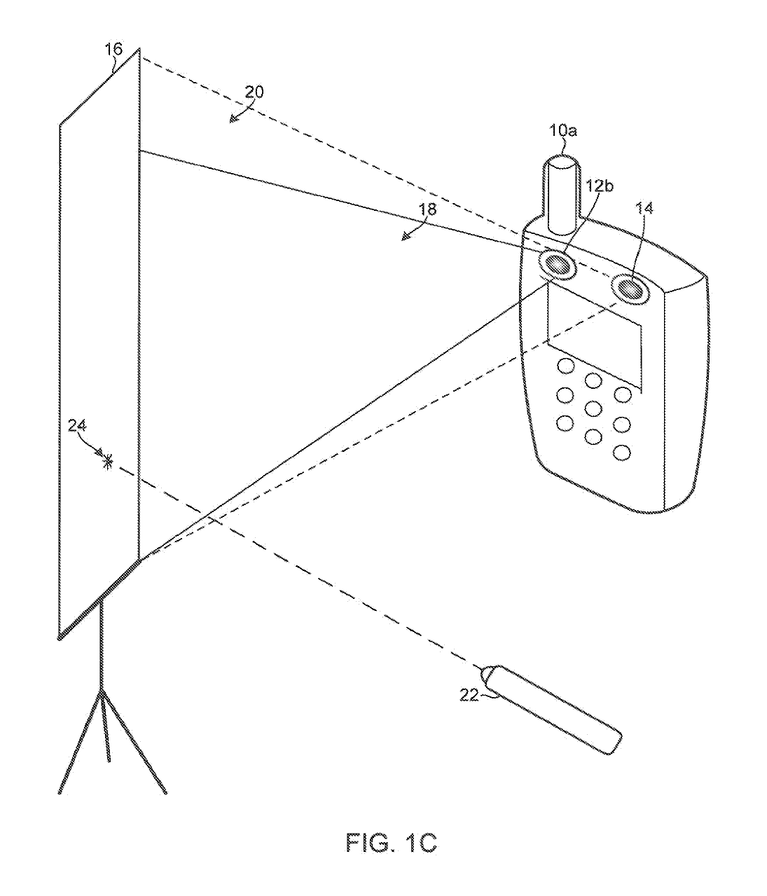

As illustrated in FIG. 1A, a system for use with the various aspects may include a computing device 10 configured to support the laser pointer gesture user interface functionality that is coupled be a cable 13 to a projector 12, which projects a computer generated image 18 (such as a presentation slide, text document or photograph) onto a projection surface 16. A camera 14 coupled to the computing device 10 may be positioned so its field of view 20 encompasses at least part of the displayed image 18. A user may then use a laser pointer 22 to place a laser spot 24 onto the displayed image 18. The laser spot 24 is generated by reflections of the laser beam from the projection surface 16; for ease of reference the term “laser spot” is used herein to refer to laser beam reflections from a surface. The camera 14 will obtain a digital image of the laser spot 24 and at least part of the displayed image 18 and provide the camera image to the computing device 10. The computing device 10 may be configured with software instructions to analyze the image generated by the camera 14 (referred to herein as the “received camera image”) to recognize at least a portion of the display content that is being projected onto the projection surface and determine the location of the laser spot with respect to the content. Since laser pointers emit a bright beam of light at a specific wavelength, laser spot can easily be recognized by the computing device 10 and distinguished from the projected image based upon the intensity and/or color elements. The computing device 10 may be further configured to track the movement of the laser spot 24 and correlate that movement to predefined laser gestures as described more fully below. When a laser gestures recognized, the computing device 10 may then execute the corresponding function.

FIG. 1A illustrates an example implementation of the various aspects in which the projector 12 is a separate component that is coupled to the computing device 10 via a cable 13, and in which the computing device 10 is a mobile device (e.g., a multifunction cellular telephone) that includes a camera 14. Modern mobile devices typically have sufficient computing power to generate images that can be projected by digital projectors as well as process the images received from the camera 14. Thus, modern mobile devices implementing the various aspects can be used as portable collaboration tools.

FIG. 1B illustrates another example implementation in which the computing device is a laptop computer 30 that includes a built-in projector 12a and camera 14a, thereby providing an integrated collaboration tool when the computing device is configured to implement the various aspects. In this aspect, the built-in projector 12a and camera 14a may be positioned on the laptop computers 30 so that the camera field of view 20 encompasses at least a portion of the projector's projected image 18. Recent developments in projection technology have resulted in projection devices that can be fit within a computing device such as a laptop computer 30. Combining the projector 12a and camera 14a within a single computing device configured with software instructions to perform the various aspect methods yields a computing device that may be very useful for collaborating with groups of people as described herein.

Recent developments in projection technology have also resulted in the availability of projectors small enough to be integrated within mobile computing devices such as cellular telephones. So called “pico projectors” have sufficient luminosity to project computer images onto a projection screen or wall and yet can fit within the packaging of many mobile devices. FIG. 1C illustrates an example implementation in which the computing device is a mobile device 10a that includes both a built-in projector 12b and camera 14, and in which the processor of the computing device is configured with software instructions to perform operations of the various aspects. Such an integrated mobile device could serve as a portable collaboration tool that may be used whenever opportunities to collaborate become available. Further, the communication capabilities provided by a mobile device 10b may be used to enable collaboration with individuals not present in a room, such as by transmitting images received by the camera 14 via wireless data links and the Internet to distant collaborators who may view the images on their own mobile device or computer.

Detection of features within the projected image by the computing device is facilitated by the fact that the image is generated by the computing device itself. Thus, by both generating the projected image and receiving a camera image of the same content, the computing device may recognize the boundaries of the projected image in and distinguish between the projected content and the portion of the camera's field of view which does not include content (i.e., area that falls outside of the boundaries of the projected image but within the camera's field of view). The computing device may be configured to recognize the projected image, and to differentiate the areas of the field of view that are occupied by the projected image from those not occupied by the image (e.g., the background or the presenter).

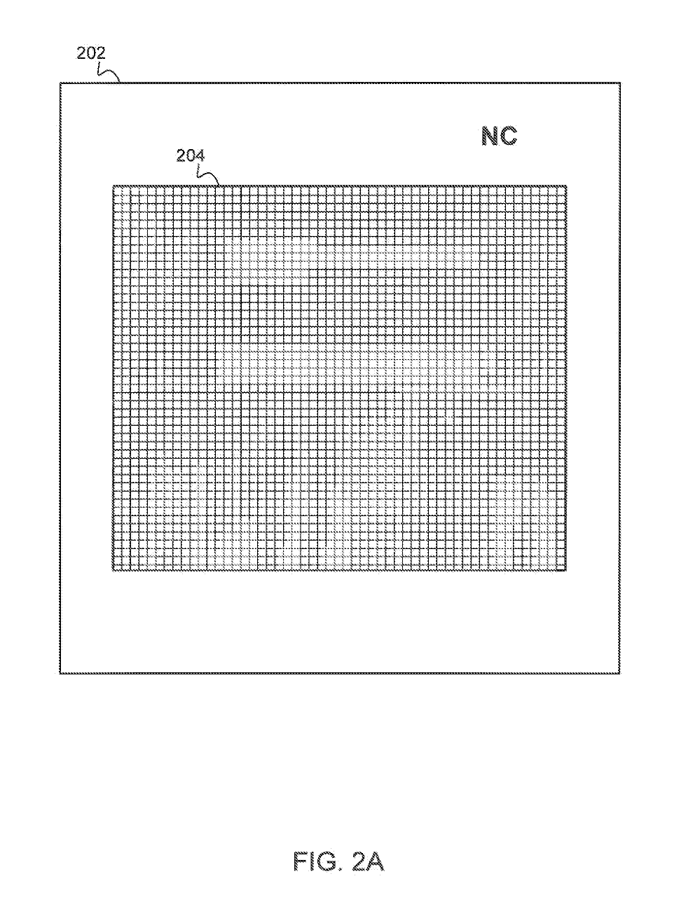

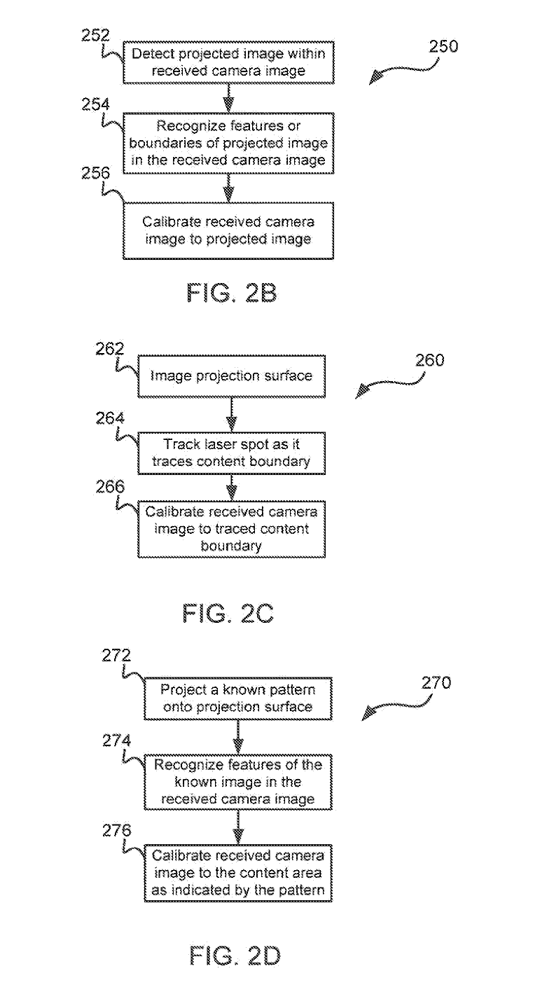

As illustrated in FIG. 2, the computing device may be configured to process the received camera image by dividing the field of view into a content (C) stage 204 (i.e., portion of the received camera image that includes the projected image) and a no-content (NC) stage 202 (i.e., the portion of the received camera image which does not include the projected image). The camera's field of view will typically include a non-content stage 202 that is larger than the projected image (i.e., content stage 204). The content 204 stage may include a system-created polygon of the displayed content, while the no-content stage 202 may be ignored for purposes of detecting laser gestures. The computing device may also divide the received camera image into a plurality of small tiles 206 to enable tracking the laser spot within the received image. In an aspect, if the projected image is larger than the field of view of the camera, the computing device may not detect a non-content “NC” stage. For example, if the entire field of view is occupied by the projected image, no “NC” areas may be determined.

The computing device may distinguish the content stage 204 from the non-content stage 202 using a variety of methods.

In a first aspect method 250 illustrated in FIG. 2B, the computing device may detect the projected image within the image data received from the digital camera at block 252, compare the received camera image to the known projected image to recognize features at block 254. This processing may use known image recognition algorithms which may be facilitated by the fact that the computing device is generating the projected image that is being recognized within the received camera image. This process may also be based upon the relative brightness of pixels within the camera's field of view since the projected image will typically be brighter than the rest of the surface on which it is projected, particularly when the lights in the room are dimmed. At block 256, the computing device may calibrate the received camera image to the recognized projected image. In an aspect, the calibration process may enable the computing device to correlate or map the desktop display (e.g., a Windows desktop) image generated by the computing device to the received camera image.

As part of the first aspect method 250, the computing device may be configured to recognize the outlines of the projected image (e.g., based on brightness) and calibrate the received camera image to the projected image so that tracking of laser spot 24 can be accomplished with respect to the boundaries of the projected image. In this aspect method at block 254, the computing device may identify four (or more) tile templates or sections of the projected image, such as the four corners of the projected content. The computing device may then match the received camera image to those templates in block 256. In performing such matching of templates to the received camera image, the computing device may scale the four tile templates from the projected image until the templates match the size of the received camera image in block 256, such as by matching recognized boundaries or corners within the received camera image. Alternatively, at block 256 the computing device may scale the received camera image until it matches the template of the projected image. In cases where the field of view of the camera is less than the extent of the projected image, such scaling may be accomplished by comparing recognizable features (e.g., dark lines and/or sharp corners) in the projected image and received camera image, and a scaling the projected image (or the received camera image) until there is a reasonable alignment among most of the recognizable features. Such scaling of the projected image or received camera image enables the computing device to correlate movement of the detected the laser spot 24 within the projected image without having to recognize actual features of the projected image, which may require more processing. Once the four corners of the projected image are identified, the computing device may be configured to scan the image provided by the camera from the four corners inwards as an optimization. The computing device may be re-calibrated in this or like manner each time the camera and/or the projector are moved.

In a second aspect method 260 illustrated in FIG. 2C, the computing device may be configured to image the projection surface at block 262, and recognize and track a laser spot during a calibration mode or process at block 264. In this aspect, a user can designate the content area by carefully tracing the perimeter of the content area with a laser pointer. In block 266, the computing device may calibrate the received camera image to the shape traced by the laser spot. As part of the processing in block 266, the computing device may correlate pixels containing the laser spot to an expected shape of the projected image, which will typically be a rectangle. At the completion of the calibration process, the computing device may determine a best fit (e.g., using a least squares approximation) of the expected shape of the projected image to the recorded path traced by the laser spot. In a variation of this process, in block 266 the computing device may be configured to treat the path traced by the laser spot as the content area regardless of its shape, thereby enabling users to designate any portion of a camera image as the content area, including an irregular shape within the boundaries of the projected image. This aspect method may enable users to freely designate the portions of the camera image that the computer should treat as the content area. Calibration processes in block 266 may involve processes similar to those described above with reference to block 256.

In a third aspect method 270, the computing device may use a known pattern, such as a checkerboard, as the projected image at block 272, and use an image processing algorithm to find recognizable features in the known pattern at block 274, such as the corners of the checkerboard. Such a function, cvFindChessboardCorners, exists in the OpenCV library. In this aspect, the known pattern may be projected onto the display surface (block 272) as part of a calibration process prior to projecting an image of a document or other content. Since the pattern is known, the computing device can match image data to the known pattern to identify the boundaries of the content and non-content areas of the projected image within the received camera image at block 274. At block 276, the computing device may calibrate the received camera image to the content area as indicated or defined by the known pattern. Thereafter, the computing device may compare subsequent laser spots to boundaries identified in such a calibration step to determine the content vs. non-content locations and orientations that it can use to characterize spot movements and recognize laser gestures of the various aspects.

The calibration process using a known projected image may also enable the computing device to calibrate the dimensions of the projected image to the received camera image so that the location of the laser spot with respect to the displayed image can be determined. This would enable the computing device to track the movements of the laser spot and provide them as inputs to an application, such as a drying application or a graphical user interface (e.g. to identify highlighted portions of the displayed image). Calibrating the projected image to the received camera image may be easier for the computing device to complete with a simple known pattern then with a more complex displayed image, such as text, PowerPoint slides or a photograph.

The computing device may further be configured to detect and track laser beam reflections that appear within the received camera image. The laser spot may be recognized based on intensity since the spot will typically be the brightest spot in the received camera image. The laser spot may also be recognized based on color since the laser light intensity is on a single specific color. For example, a helium-neon laser, which is the typical red laser pointer, has a bright spot that can be recognized by its luma (i.e., brightness) component at 225. But the laser spot can also be recognized by the chroma component of the camera image pixels containing the laser spot since the intensity of the red chroma component (Cr) will be much greater than the blue chroma component (Cb). Thus, the computing device may recognize a red laser spot by comparing the color balance of each pixel; those pixels whose red component (Cr) is much greater than the blue component (Cb) (i.e., Cr>>Cb) contain the laser spot. Green laser spots can similarly be recognized based on the difference between the green chroma component (Cg) and the blue (Cb) or red (Cr) components. Note that this method is not limited to a particular type of color space of color range sensitivity of the digital camera.

in a further embodiment, the computing device may be configured to perform a calibration step to enable it to calibrate the laser spot recognition process (e.g., to select threshold values for Cr, Cb and Cg chroma components to use in identifying the laser spot). This aspect method may enable the computing system to accommodate differences in laser output, as well as to accommodate future laser pointers which may emit light at different wavelengths (i.e., not red or green). In this aspect, a calibration step or process may be provided during which users may be prompted to shine their laser pointer at a particular portion of the displayed image, such as the center of the screen or within a projected square or circle. For example, as part of calibrating the received camera image to the projected image, such as with the projection of a known pattern (e.g. a checkerboard), participants may be prompted to shine their laser pointers at a particular square or location in the image, such as the center of the projected image. The computing device may then process the received camera image in the location designated for the laser spot to measure and record the respective intensities in the primary color space of the camera (e.g., red-green-blue). Using the measured intensities, the computing device may then set threshold values for one, two or all three of the color components and brightness (e.g., a luma value of 20 out of 255) against which pixels may be tested to reliably identify the calibrated laser spot.

Calibrating the computing device in the digital camera to particular laser pointers may be useful to enable participants to designate one or more laser, pointers for use as user-interface pointers while other laser pointers can be used in the ordinary manner to indicate portions of the displayed image. Thus, those laser pointers which were shined on the calibration spot of the projected image during the calibration process may be recognized by the computing device thereafter as laser spots to track for purposes of recognizing laser gestures, while other laser spots may be recognized based upon their color luminosity as laser spots to be ignored.

In a further aspect, users may be presented with a menu from which users may select the type of laser pointer being used, such as from a list of red, green, blue, etc. In this aspect, the computing device may look up the appropriate threshold color/brightness intensity thresholds from a pre-loaded data table based upon the user response to the menu prompt.

In a further aspect, the computing device may be configured to recognize and differentiate two different laser colors, such as red and green lasers, so that different color laser pointers may be used simultaneously. This aspect may enable the computing device to recognize each color laser as a separate user input, so that two users may interact with the projected image simultaneously. Alternatively, this aspect may enable the computing device to recognize different functions or laser gestures depending upon the color of the laser spot. In this manner, the number of recognizable laser gestures may be doubled, or one color laser gesture may be recognized as indicating a function while the other color laser indicates user inputs to applications, such as drawing of lines or letters.

In a further aspect, laser spots of different colors may be assigned different priorities by users. For example, user settings or choices may assign higher priority to green laser spots and then to red laser spots. In this manner, when green and red laser spots are shown on the screen at the same time, the computing device may ignore the lower priority laser spot (i.e., a red spot in this example) and track the green spot to the determine whether it is tracing a laser gesture. Such prioritization of laser colors may be extended to as many different color lasers as our available. This assignment of priority two different laser colors may be useful in many typical presentation situations where more many people have laser pointers and many people are interacting with the displayed image, but one participant has priority (e.g., the boss). By giving the boss a particular color laser pointer that no other participant has, and assigning that color laser spot the highest priority, the computing device may be configured to ignore all other laser spots when the green spot is detected on the displayed image. In this manner, while participants can interact with the computing device with their red laser pointers until the boss takes over by shining a green laser pointer. The setting of laser color priorities may also be included as part of the calibration step described above.

The computing device may be configured to track the location and movement of a laser spot with the projected image as correlated to the received camera image. In an aspect method, the computing device may do so by breaking the received camera image into small tiles (e.g., groups of pixels) and detect the tile or tiles in which the laser spot is are located. If the detected laser spot shifts from one tile location to another, this indicates that the spot is moving with respect to the projected image. Knowing the relationship of one tile to the next, the computing device can easily determine the direction and rate of movement. By correlating the received camera image to the projected image as described above, the computing device can correlate the tiles to particular locations within the projected image. Thus, the computing device can easily determine the location of the laser spot within the projected image. By tracking the location of the laser spot within the received camera image over time, and comparing such movement to predetermined patterns, the computing device can characterize the location and movement of the laser spot.

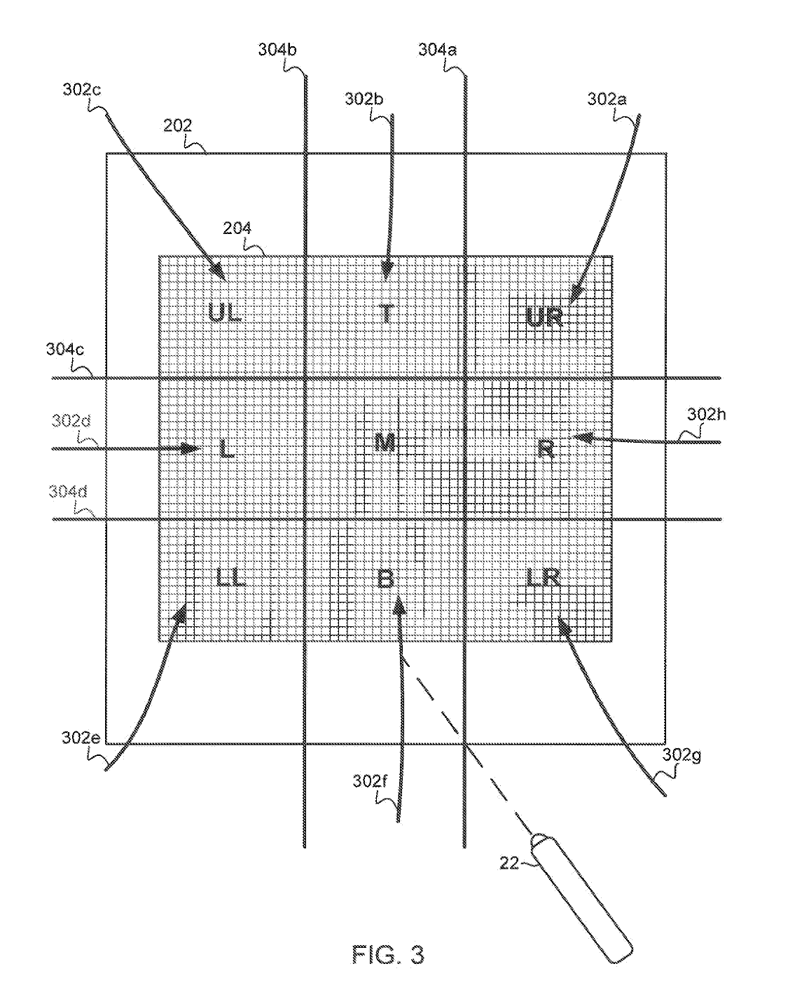

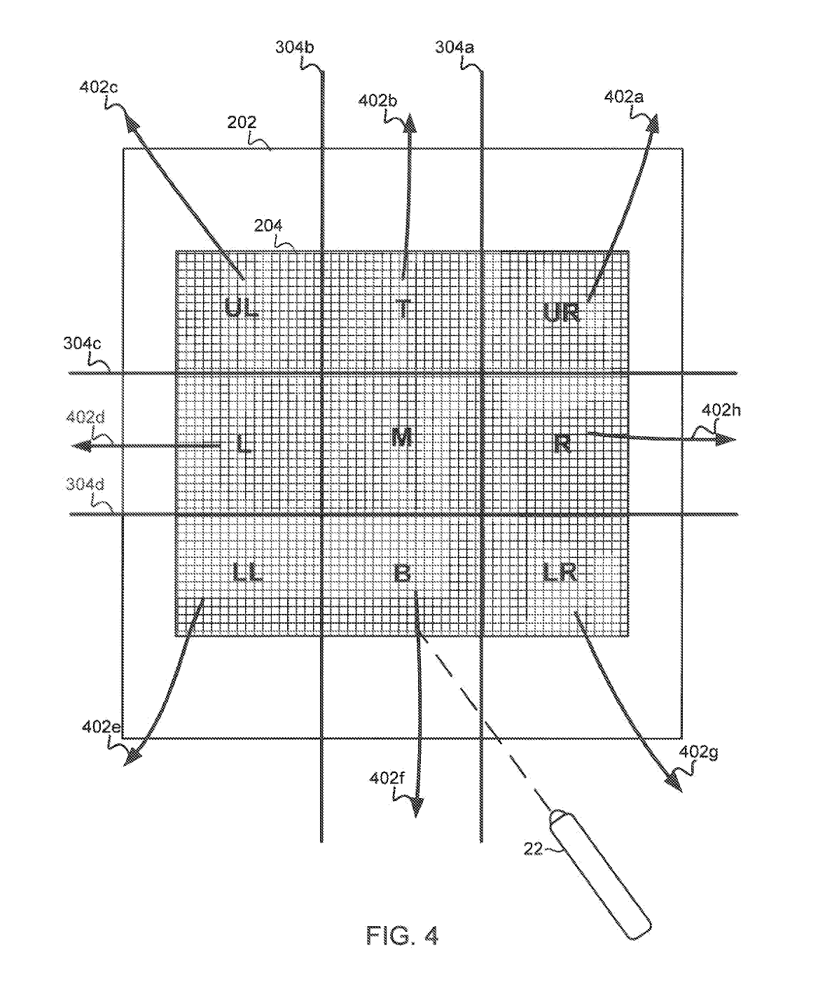

The computing device may segment the entire received camera image into small tiles and track the laser spot within tiles that correspond to the projected image. Alternatively, the computing device may segment the portion of the received camera image that corresponds to the projected image into tiles. For example, in an aspect, the computing device may divide the portion of the received camera image corresponding to the projected image into nine tiles, such as tiles corresponding to the four corners, the center, and the four midpoints between to respective corners of the projected image. Such segmentation of the projected image is illustrated in FIGS. 3 and 4, which include upper left (UL), top (T), upper right (UR), right (R), lower right (LR), bottom (B), lower left (LL), left (L), and middle (M) defined by boundary lines 304a, 304b, 304c, 304d. The computing device may then track the location of the laser spot from a laser pointer 22 with respect to the nine tiles defining the legions of the projected image. In this manner, the computing device can track the laser spot with respect to the nine recognizable portions of the projected image, without having to analyze the laser spot with respect to particular pixels or small elements of the projected image.

The computing device may further be configured to track the location and movement of the laser spot with respect to time so that the laser spot movement within a time period can be determined. A laser beam movement may be characterized by determining the location and movement of a laser spot from the time that the laser spot is detected within the projected image until the laser spot disappears or leaves the projected image. In order to enable the computing device to differentiate between normal pointing uses of laser pointers (e.g., to point the attention of the audience to parts of the projected image) and laser gestures tied to functions, several basic and easily recognizable movements or patterns can be defined. Thus, the computing device may be configured to track the laser spot but not recognize and process its path as a laser gesture until it follows one of the predefined movements or patterns. For example, several recognizable movements or patterns may be defined based upon a set of basic movements of the laser spot with respect to the nine tiles of the projected image. For example, a movement of a laser spot entering the content area C from the left side (L) and moving towards the middle (M) of the content area would represent a particular unique laser gesture which may be identified in a shorthand or code for use in correlating the detected laser spot movement to a particular laser gesture, such as “L:NC;;M:C.” Laser gestures may also be recognized based upon laser spot movements performed between recognizable gestures. For example, a laser gesture may be in the form of a letter or standard shape that is traced by a laser spot within the content area after the laser spot enters the content area from the non-content area, with the end of letter or shape trace indicated by the laser spot leaving the content area for the non-content area.

In an aspect, each recognizable laser gesture may be associated with a predetermined function that may be performed by the computing device. Such characterization-function relationships defining laser gestures may be predetermined or customized based on the user preferences. Further, laser gesture characterization-function relationships may be application-dependent. For example, the laser gesture described above “L:NC;;M:C” may be associated with a “Next Slide” function to change the displayed in a slide presentation application, while the same laser gesture may be correlated to the “end” function to exit or terminate an application, when used when a different application is running on a computing device.

FIG. 3 illustrates eight example laser gestures 302a-302h that may be executed according to an aspect in which the content area is divided into nine tiles as described above. The laser gestures illustrated in FIG. 3 feature movement of a laser spot from outside of the content area towards the center of the content area. For example, line 302a illustrates a laser gesture in which the laser spot enters the content area 204 from the non-content region 202 in the upper left (UL) content region moving towards the middle (M) region. Line 302b illustrates a laser gesture in which the laser spot enters the content area 204 from the non-content region 202 in the top (T) content region moving towards the middle (M) region. Line 302c illustrates a laser gesture in which the laser spot enters the content area 204 from the non-content region 202 in the upper left (UL) content region moving towards the middle (M) region. Line 302d illustrates a laser gesture in which the laser spot enters the content area 204 from the non-content region 202 in the left (L) content region moving towards the middle (M) region. Line 302e illustrates a laser gesture in which the laser spot enters the content area 204 from the non-content region 202 in the lower left (LL) content region moving towards the middle (M) region. Line 302f illustrates a laser gesture in which the laser spot enters the content area 204 from the non-content region 202 in the bottom (B) content region moving towards the middle (M) region. Line 302g illustrates a laser gesture in which the laser spot enters the content area 204 from the non-content region 202 in the lower right (LR) content region moving towards the middle (M) region. Line 302h illustrates a laser gesture in which the laser spot enters the content area 204 from the non-content region 202 in the right (R) content region moving towards the middle (M) region.

FIG. 4 illustrates eight more example laser gestures 402a-402h in which the laser spot moves away from the center of the content area (M) and into the non-content area (or beyond the received camera image) through a particular region the content area. For example, line 402a illustrates a laser gesture in which the laser spot begins in or near the middle (M) region of the content area 204 and moves toward the non-content region 202 through the upper right (UR) content region. Line 402b illustrates a laser gesture in which the laser spot begins in or near the middle (M) region of the content area 204 and moves toward the non-content region 202 through the top (T) content region. Line 402c illustrates a laser gesture in which the laser spot begins in or near the middle (M) region of the content area 204 and moves toward the non-content region 202 through the upper left (UL) content region. Line 402d illustrates a laser gesture in which the laser spot begins in or near the middle (M) region of the content area 204 and moves toward the non-content region 202 through the left (L) content region. Line 402e illustrates a laser gesture in which the laser spot begins in or near the middle (M) region of the content area 204 and moves toward the non-content region 202 through the lower left (LL) content region. Line 402f illustrates a laser gesture in which the laser spot begins in or near the middle (M) region of the content area 204 and moves toward the non-content region 202 through the bottom (B) content region. Line 402g illustrates a laser gesture in which the laser spot begins in or near the middle (M) region of the content area 204 and moves toward the non-content region 202 through the lower right (LR) content region. Line 402a illustrates a laser gesture in which the laser spot begins in or near the middle (M) region of the content area 204 and moves toward the non-content region 202 through the right (R) content region.

Each of the laser gestures 302a-302h and 402a-402h illustrated in FIGS. 3 and 4 are easily recognizable, easy to learn and implement using a standard laser pointer 22, and may be assigned to different functions of the computing device. Thus, these figures illustrate how simple movements of a laser pointer 22 can be used to indicate 16 different gestures that the computing device can recognize and correlate to a corresponding predetermined function.

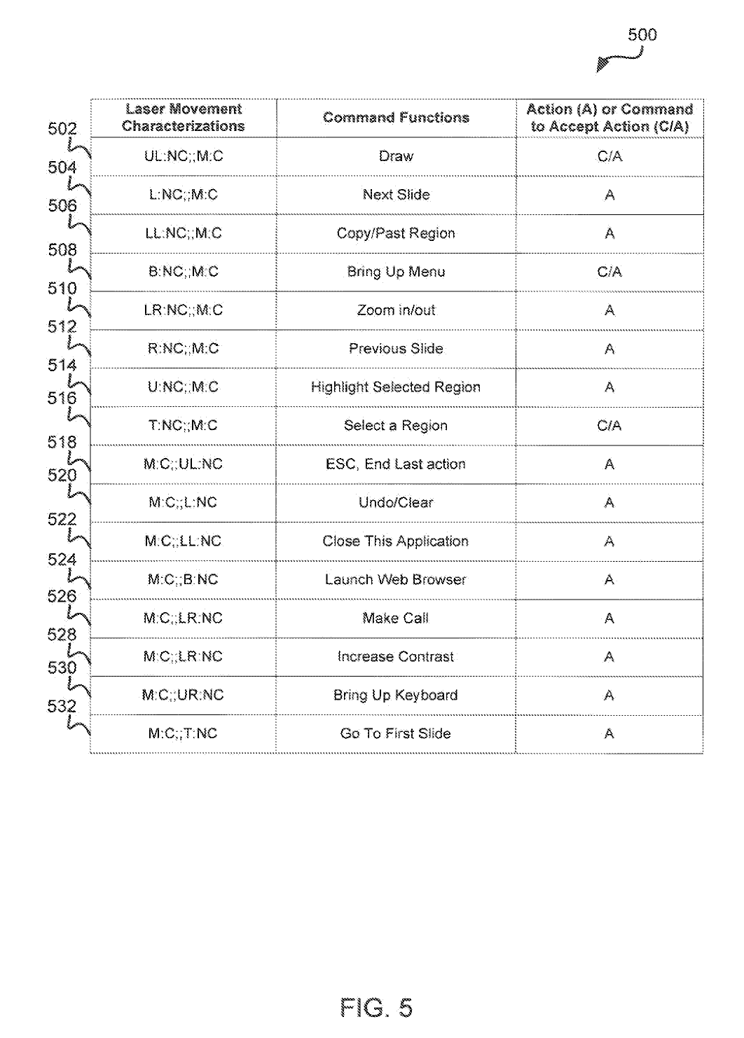

A simple data structure, such as the data table 500 illustrated in FIG. 5, may be used to identify a function indicated by a particular laser gesture recognized by the computing device. Once the computing device characterizes the movement of a laser spot within the received camera image based on the location and movement of the laser spot with respect to the projected image (i.e., content area 202), the computing device may perform a table lookup function using a data table 500 to determine the function corresponding to the detected gesture. To enable such a data lookup process, the data table 500 may include information such as the Laser Movement Characterization by which the laser gesture can be recognized, and the Command Functions correlated to particular laser gestures. The data table 500 may also include additional information regarding the nature of a function that the computing device can use in performing the function, such as, whether the function indicates that an action (A) should be taken, or that the function is a command to accept another action (C/A). For example, a laser gesture correlated to activating a drop functionality (thereby enabling a user to draw on the projected image using the laser pointer 22) would be a command to activate a function that will receive subsequent laser spot movements as an input (e.g., drawing), and not as new laser gestures. As another example, a laser gesture correlated to a “next slide” function requires no further input, so the computing device can immediately take action upon recognizing the laser gesture (i.e., displaying the next slide in a presentation) and evaluate subsequent laser spots as a new laser gesture.

For example, as shown in data record (row) 502, a laser movement characterization of “UL:NC;;M:C” (i.e., moving from the upper left of the non-content area towards the middle of the content area, as illustrated in line 302c in FIG. 3) could be an associated with a “Draw” Function. Accordingly, when the computing device detects a laser spot entering the content area from the non-content in the Upper Left region moving towards the middle region M of the content area 202, the computing device may use the data table 500 to determine that a draw application should be implemented (e.g., to accept drawings on the current projected image), and track the laser spot as inputs to the drawing application. In this example, the computing device may draw a line on the projected image wherever the laser spot moves, thereby allowing participants to mark up a projected document using a laser pointer 22 without having to use a computer mouse or drawing pad.

The computing device may use the “A” or “C/A” designation to determine the number of steps necessary to implement the functionality indicated by a laser gesture. For example, as shown in row 502, a computing device may determine from the “C/A” value stored in that data record that the “Draw” function is a multi-gesture function so the next detected laser spot should be treated as an input and not as another laser gesture. Thus, the first laser gesture places the computing device in the “Draw” mode in which the computing device waits for a second laser spot which it detects and uses the location information as an input to the draw application. For example, a user may use the “Draw” laser gesture to prompt the computing device to enable the user to draw a box around certain contents in the projected image using a laser pointer 22.

Data record 504 illustrates a one-step command function. So when the computing device tracks the movement of a laser spot and characterizes its movement as “L:NC;;M:C”, the computing device may determine from the table look up that the associated command function is “Next Slide”. Data record 504 further indicates (with the “A” the third column) that no further inputs are required. Accordingly, once the associated command function is determined, the computing device executes the function and treats subsequent laser spot detections as potential laser gestures. Columns 506 to 532 illustrate other laser movement characterizations and example associated command functions that may be recognized by a computing device.

Data table 500 illustrates how the simple laser gestures illustrated in FIGS. 3 and 4 can be correlated to 16 separate useful functions may be implemented on a computing device. The functions correlated to each of the 16 laser gestures are for illustration purposes only and any number of different functions and different function-to-gesture correlations may be implemented.

In an aspect, some command functions correlated to particular laser gestures may depend upon the application that is running on the computing device, while other laser gestures may be assigned to standard functions. Further, some command functions may not be available in certain applications. For example, the command function “Next Slide” may only be available in slide presentation or photo viewing applications. Accordingly, each application may include its own unique laser gesture look up table 500 with each laser movement characterization associated with a different command function.

An example laser gesture and functionality may enable users to map laser spot movements on the projected image to movements of a “control mouse,” enabling user to move a cursor about the screen and activate left and right mouse buttons simply by moving the laser spot. For example, a movement from upper left non-content towards the middle of the content stage (i.e., UL:NC::M:C) could be assigned the functionality to place a WindowsXP cursor at the location of the laser spot and to track the laser spot as if it were a mouse input. Mouse button functionality may then be linked to particular recognizable laser gestures, such as a left-right shaking gesture could be recognized as a left button input and an up-down shaking gesture may be recognized as a right button input, or vice versa. In this mode, users may interact with a projected image just as if they were pointing with a touch pad or computer mouse.

The data table illustrated in FIG. 5 also illustrates how the functionality corresponding to laser gestures can be easily configured by means of simple data structures. With a standard characterization of laser movement, developers and users can define additional laser gestures simply by adding to the data table 500.

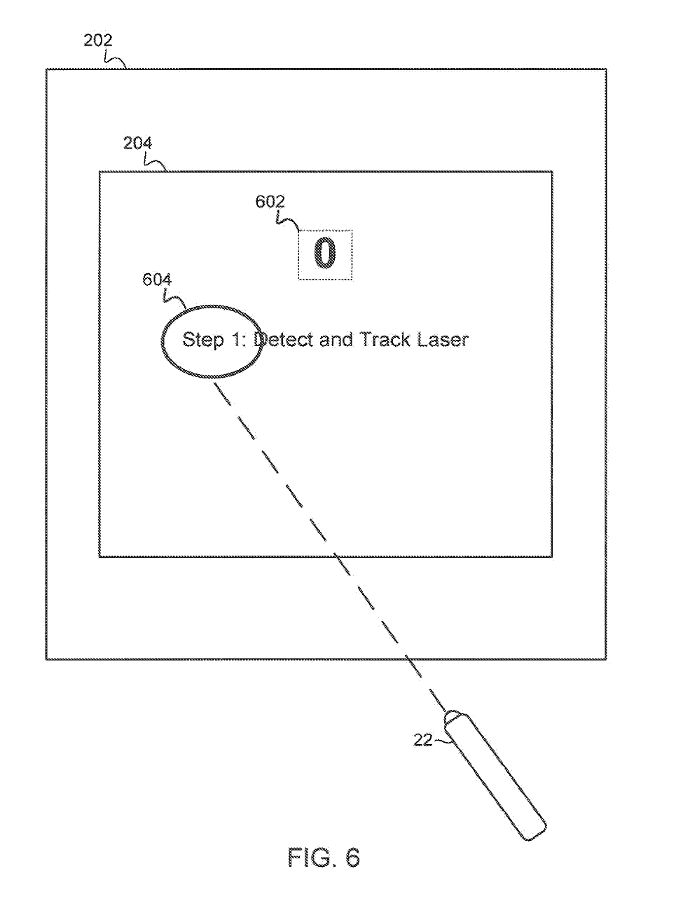

FIGS. 6-12 illustrate example implementations, functions, and uses of the various aspects.

FIG. 6 illustrates an implementation of a laser gesture to activate a “Draw” application or functionality according to an aspect. Once the “Draw” application or functionality has been activated by a laser gesture, the computing device may be configured to detect the location of subsequent laser spots within the content area C and accept those locations as drawing inputs for some period of time or until the drawing application is terminated. Thus, activating a draw functionality may allow users to “draw” on the projected image with a laser pointer until the function times out. Alternatively, the draw function may await a laser spot for a period of time, and deactivate the draw functionality if no laser spot is detected within that period. In a third alternative, the drawing function may pause for a predetermined amount of time before accepting laser inputs, thereby giving users time to position the laser spot at a desired starting point for a drawing movement, or practice the desire movement before the computing device begins recognizing the laser spot as a drawing input. Optionally, the computing device may be configured to display a countdown timer 602 to inform the user of the time remaining to perform drawing motions, time before drawing inputs will be accepted, or time before the drawing function will terminate if no laser drawing is started. FIG. 6 shows an example of a user employing a laser pointer 22 to trace an ellipse 604 around the word “Step 1:” after the threshold period timer 602 shows “0.” In a drawing application the detected laser spot path may be accepted as an input on the displayed document as if the user had traced the path using a computer mouse, touch pad or touchscreen.

FIG. 6 is also illustrative of the use of laser gestures to select or highlight portions of the projected image. In response to detecting a laser gesture to accept a selection input, the computing device may track subsequent laser spots as tracing a path around content within the projected image to be selected. Once a closed path of the laser spot is detected or the laser spot disappears, the computing device may select the encircled projected content just as if the user had made the content selection using a computer mouse, touch pad or touchscreen. Thus, a user may select the term “Step 1:” by drawing a circle around this portion of the projected image as illustrated. Once selected, the term may be edited, cut, moved, or otherwise manipulated. Similarly, a user may highlight a portion of the projected image by tracing a closed path around the portion with a laser pointer after signaling a highlight functionality with a laser gesture. Once a closed path of the laser spot is detected or the laser spot disappears, the computing device may color, highlight or otherwise emphasize the selected portion of the projected image. Such highlighting may be useful in presentation to emphasize a portion of the projected image.

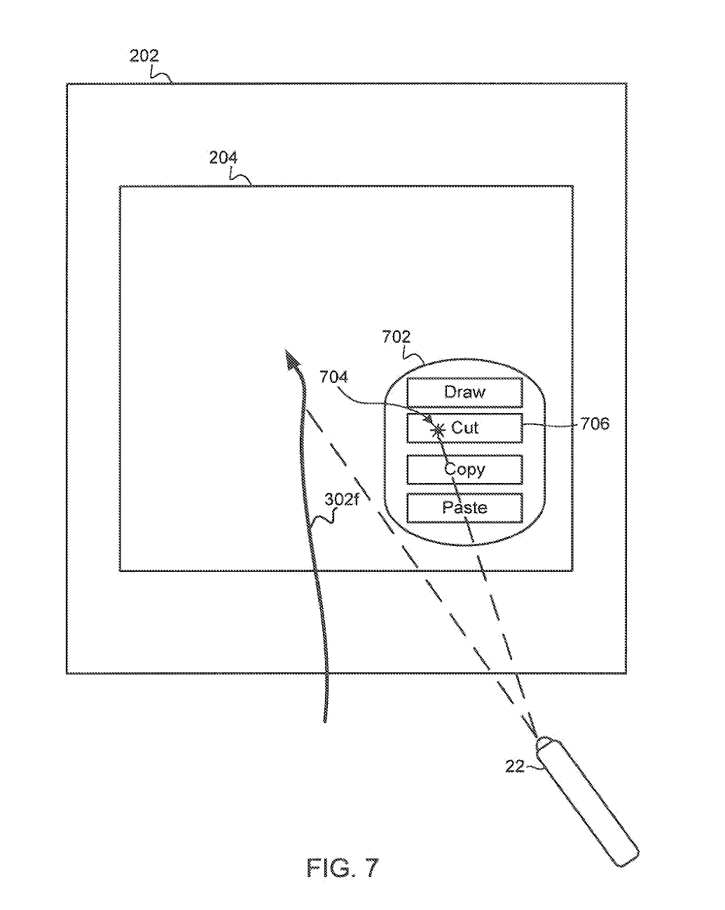

In an aspect illustrated in FIG. 7, a computing device may implement a menu function in response to a particular laser gesture to provide users with function selections that can be made by shining a laser point on a menu item within the projected image. In response to detecting the illustrated laser gesture 302f (which might be characterized as “B:NC;;M:C”), the computing device may determine that the laser gesture corresponds to a command to bring up a user interface menu 702 appropriate for the current application. In the illustrated example, the user interface menu 702 includes menu options “Draw,” “Cut.” “Past,” and “Copy,” which may be implemented using a laser pointer. The computing device may wait to detect a laser spot within the projected menu 702. A user may select one of the menu options by shining the laser spot on the desired menu item. For example, FIG. 7 shows a user selecting the “Cut” function by shining the laser spot 704 on the “Cut” menu item box 706 and holding the beam steady in one spot for a certain period of time. The computing device may be configured to interpret an approximately steady laser spot within a menu item box on the projected image as indicating the selection of the corresponding menu item. The computing device may use any of the methods described above for determining when the laser spot is within a menu item box. When a menu selection is determined, the computing device may then implement the corresponding functionality as if the selection had been made using a conventional user interface device (e.g., a mouse, touchpad, touchscreen or keyboard).

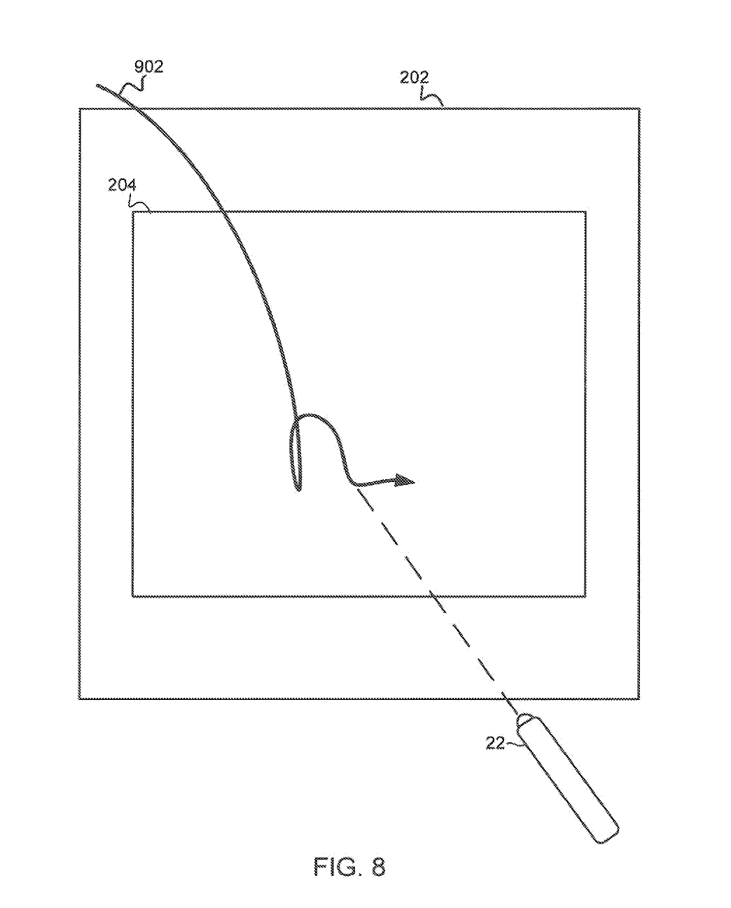

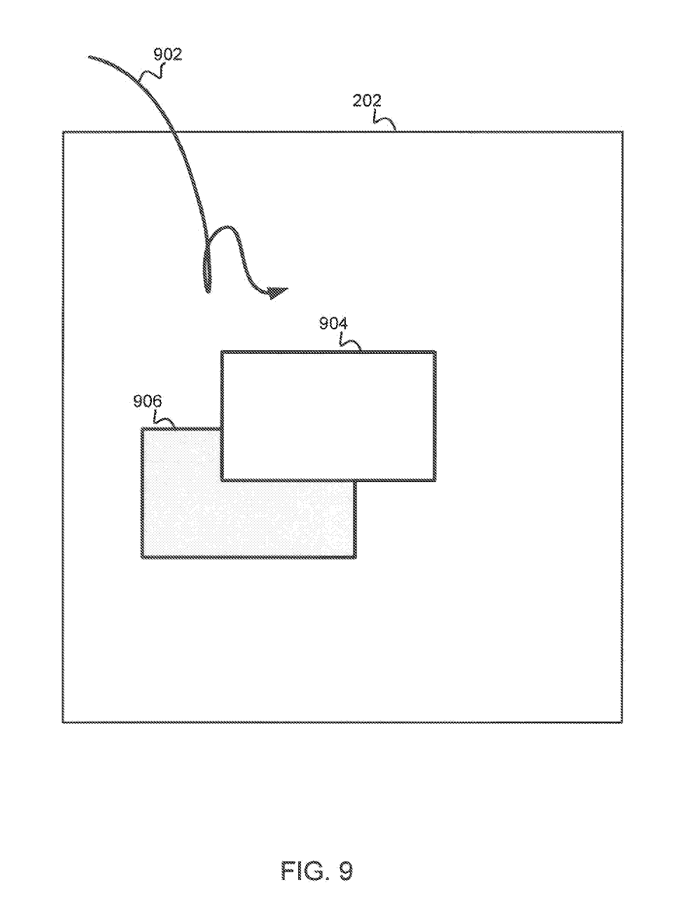

In an aspect illustrated in FIGS. 8 and 9, a computing device may be configured to recognize traced laser gestures as alphabet letters or shapes that may be used as inputs to the computing device (e.g., to input a command, add a note or edit projected text).

In an aspect illustrated in FIG. 8, a computing device may be configured to recognize when a laser spot within the field of view of the camera moves from the non-content stage 202 and traces an alphabet letter in the content stage 204. A computing device may characterize a laser beam reflection that traces the letter “n” as shown with the line and arrow 902. The computing device may characterize the movement of the laser spot through a plurality of small tiles (e.g., the small tiles 206 illustrated in FIG. 2) and use a table look up process to determine a traced letter using a data table correlating traced shapes to ASCI values. The computing device may use methods for recognizing letters traced on the projected image by a laser spot that are based on algorithms used for recognizing letters traced on a touchscreen.

A data table used to recognize traced shapes may include standard shapes and may also be user-trainable, so that users can define their own free form laser gestures for interacting with the computing device with a laser pointer. For example, tracing an “n” on the projected image with a laser pointer 22 may be correlated to the “Next Slide” when a presentation application is running on the computing device. Thus, when the computing device recognizes a laser spot movement tracing an “n” within the content area, the next presentation slide may be projected.

In an aspect illustrated in FIG. 9, a computing device may also be configured to recognize traced letters or shapes outside of the content area in the non-content stage 202 of the camera's field of view. This aspect may be particularly useful when the projected image or content stage 204 is much smaller than the field of view of the camera or non-content stage 202, or more than one application is running on the computing device with content included within the projected image. As mentioned above, each application may have its own laser gesture data table identifying laser movement characterizations and associated command functions specific to the application. The computing device may be configured to relate laser gestures detected outside of the content stage to the open application. In the event that two applications are running at the same time, the computing device may be configured to apply any traced laser gestures to the application that is currently selected and in running in the foreground. As such, to command a function in an application, the user must first select and bring to the foreground the application with which he desires to interact. For example, if a slide presentation application 904 is open, tracing of the letter “n” using a laser beam in the non-content stage, as shown by line and arrow 902, may select the next presentation slide image. The traced gesture may not affect the other applications 906 which are running in the background.

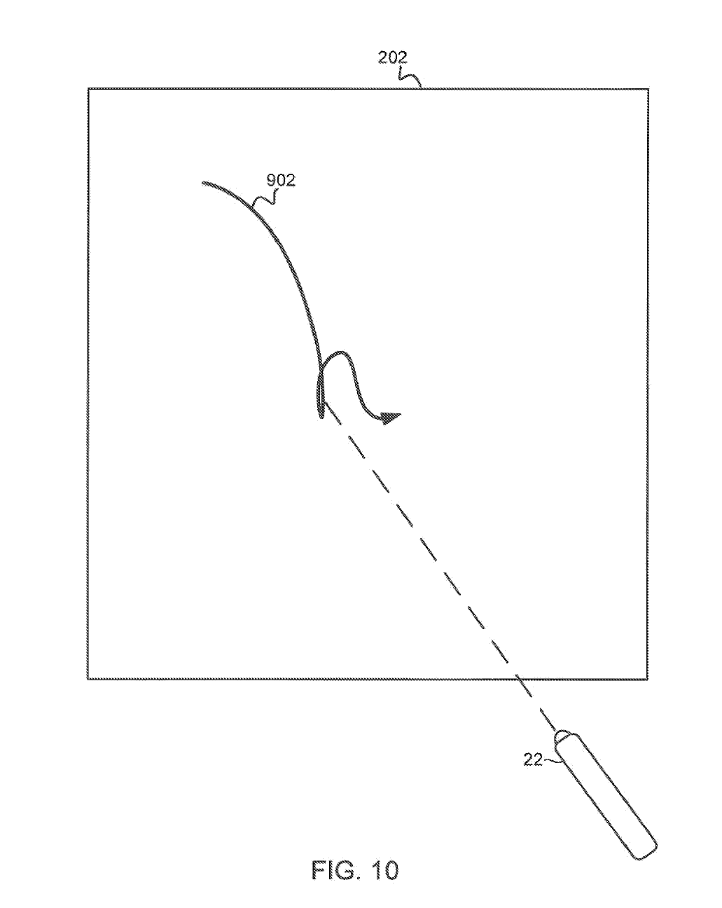

In a further aspect as illustrated in FIG. 10, a computing device may be configured to enable users to interact with the computing device user interface by detecting and characterizing traced laser gestures on an external surface using a laser pointer 22 without the need for a projected image. In this aspect the computing device may be equipped only with a camera (i.e., no projector). Using the methods and laser gestures described herein, the computing device may be configured to enable users to interact with an application by shining a laser beam on a surface within the non-content area 22 of the camera's field of view. The computing device may be configured to detect and characterize the laser gesture as letters (e.g., the letter “n” as illustrated) or commands.

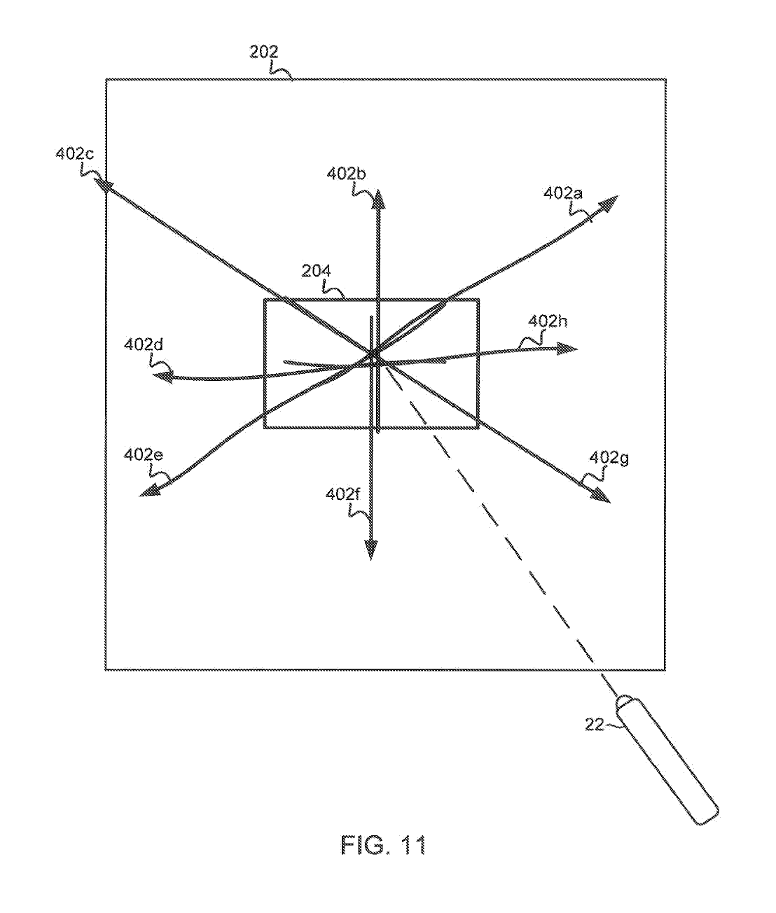

While FIGS. 3 and 4 illustrate laser gestures in which the content area 204 of the projected image is a significant portion of the camera field of view, this is not a requirement. FIG. 11 illustrates how the laser gestures can be recognized even when the projected image content stage 204 is small. When the projected image is small, it may be difficult for users to accurately shine a laser spot within the nine segments of the contents stage 204 illustrated in FIGS. 3 and 4. In such situations, the computing device may trace the laser spot movement within the non-content stage 202 portion of the field of view to accurately identify the intended laser gesture. For example, when the projected image 204 is very small, the computing device may trace the direction of the laser gesture within the non-content stage to characterize the traced laser gestures in a manner similar to that described above with reference to FIGS. 3 and 4. Thus, even though the starting point of laser gestures 402a to 402h shown in FIG. 11 may not be in the middle M region or exit the content stage precisely within one of the eight periphery regions shown in FIGS. 3 and 4, the continued path within the non-content region 202 can be used by the computing device to determine the intended gesture. For example, laser gesture 402b which exits the content stage from the top region begins in the bottom B region of the content area instead of the middle M or top T. The computing device can rely on the extended path within the non-content region which departs from the top T region of the content stage to distinguish the laser gesture from others.

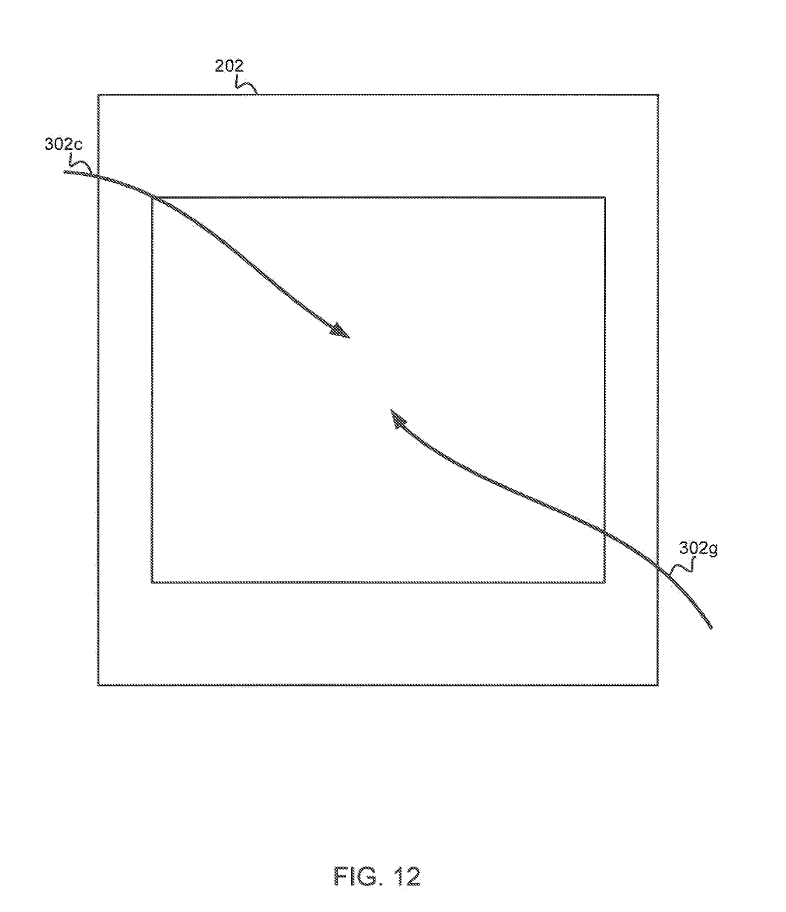

In an aspect illustrated in FIG. 12, a computing device may be configured to detect and track multiple laser spots simultaneously. This may occur when several people equipped with laser pointers 22 are collaboration in a room on a projected image. To accommodate this likely situation, the computing device may be configured to distinguish widely separated laser spots as separate inputs, and characterize each laser trace separately, and determine whether each traces a laser gesture. If more than one laser gesture is detected, the computing device may employ as triage or prioritizing algorithm to determine which corresponding function should be implemented. In a further aspect, multiple simultaneous laser gestures may be interpreted as a single input, so that a user may employ two laser pointers 22 like two fingers on a multi-touch touchscreen. For example, FIG. 12 shows two laser pointers tracing two separate laser gestures 302c, 320g each coming into the content stage 204 from the non-content stage 202 from opposite directions. The computing device may detect the two laser gestures, characterize the traces and correlated the traces to one function, such as a zoom-out function. In a further example, a zoom-in function may be implemented by tracing two laser gestures in the opposite direction (i.e., from the middle outward).

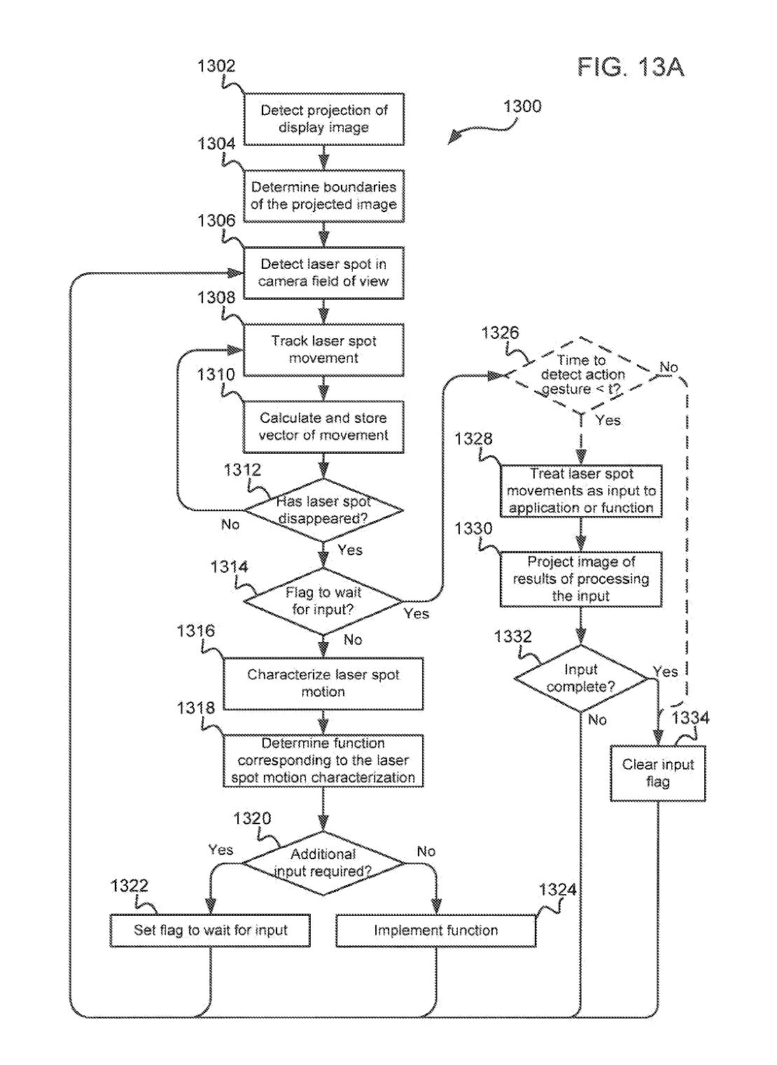

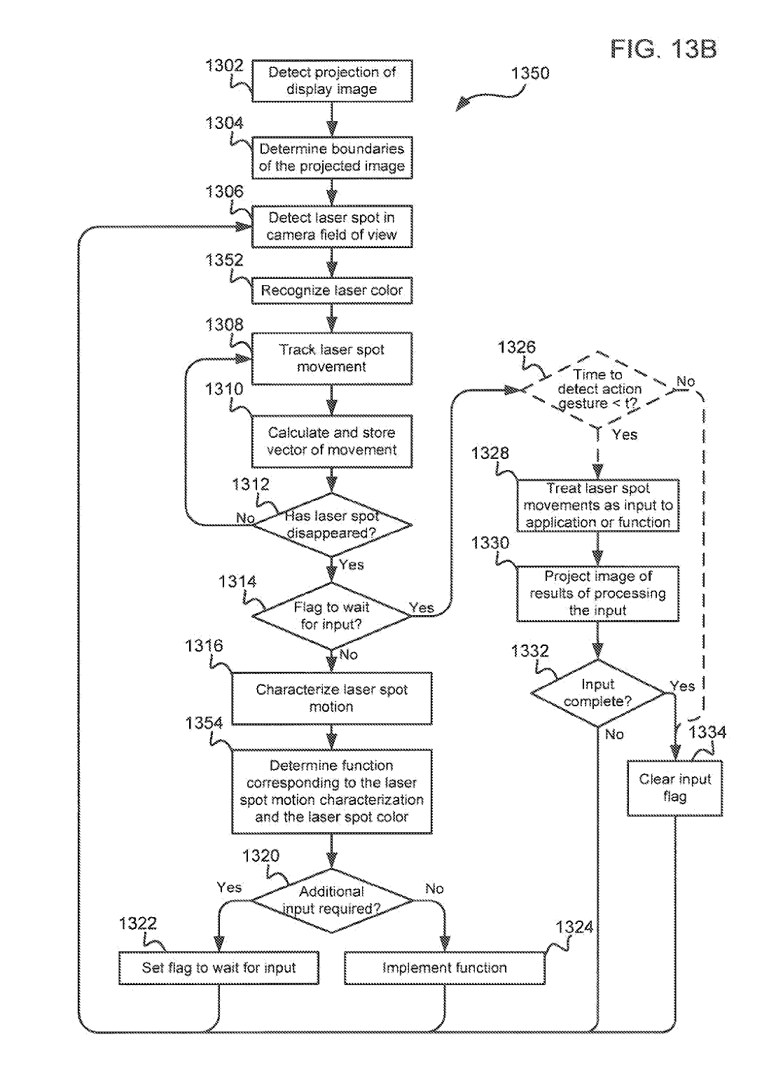

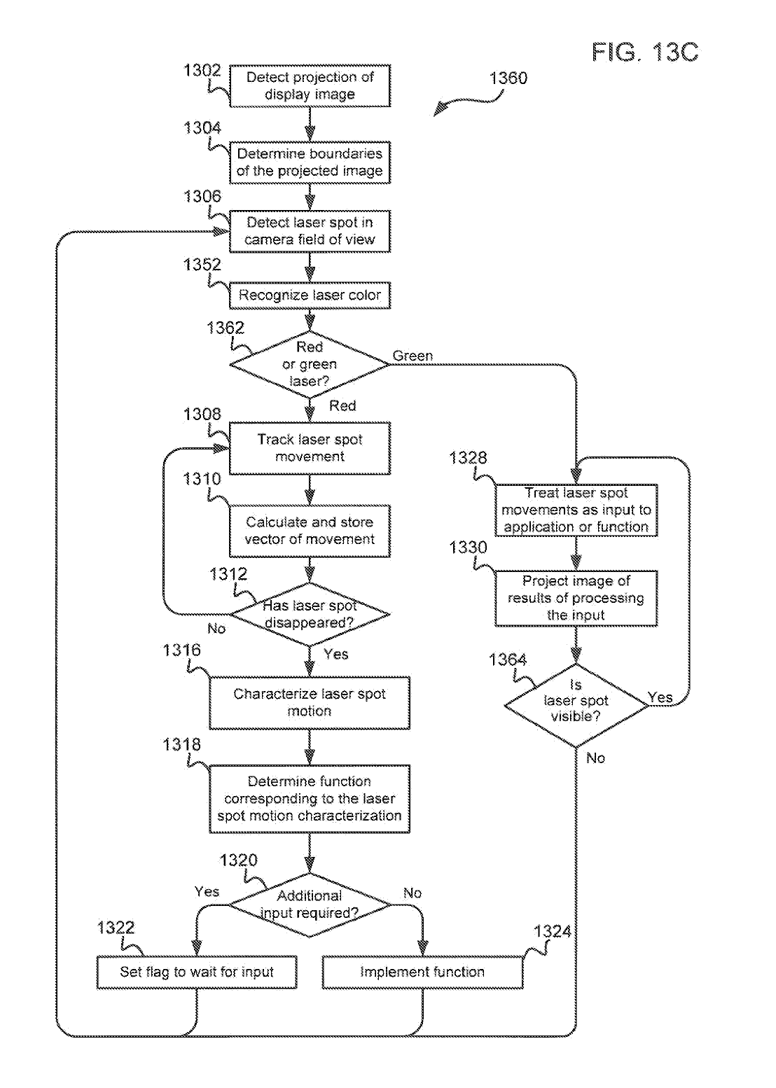

FIG. 13A illustrates a first aspect method 1300 for implementing a user interface accepting laser gestures detected by a camera coupled to a computing device. In method 1300 at block 1302, a computing device may be configured to receive image data from a digital camera and detect within the received camera image a projection of a computer-generated image. At block 1304 the computing device may process the received camera image to determine the boundaries of the projected image. As discussed above, this process may use well known processes and algorithms for detecting the edges of the projected image. Also, the computing device may use image recognition techniques to recognize portions of the computer-generated image appearing within the received camera image. As part of block 1304, the computing device may further process the received camera image to scale the image to the correspond to the projected image (or vice versa), so that the computer device can correlate a location of a detected laser spot in the camera field of view to a location within the computer-generated projected image.

At block 1306 the computing device may detect a laser spot within the field of view of the camera. As described above, the computing device may detect the laser spot and distinguish it from the projected image based upon the light intensity within one or a few image pixels, based upon relative color intensity within one or a few image pixels, or a combination of both light intensity and color balance. As part of block 1306, the computing device may also determine the location of the laser spot within the field of view of the camera and/or within the projected image. As described above the computing device may divide the camera point of view into tiles and identify the laser spot location based upon the image tile in which the spot appears. Such tiles may be applied to the entire field of view or just to the recognized projected image.

At block 1308, the computing device may track the movement of the laser spot. This process may involve detecting when the laser spot transitions from one tile to another. Also as part of block 1308, the computing device may determine whether the laser spot color is calibrated or designated to be used for laser gestures, and only track the laser spot movements if it is recognized as a laser spot which authorized to make laser gestures. Also, as described above, different laser spot colors may be assigned different priorities, so as part of block 5008, the computing device may determine if multiple laser spots are present and select the laser spot with the highest priority color for tracking. At block 1310, the computing device may analyze the movement of the laser spot, such as to determine a direction or vector of movement, and store information about the movement (e.g., the vector) in memory. The processing of the movement of the laser spot may be accomplished by recording the tiles in which the laser spot appeared over time.

At determination block 1312, the computing device may determine whether the laser spot has disappeared. If the laser spot is still visible (i.e., determination block 1312=“No”), the computing device may return to block 1308 to continue tracking the laser spot movements. If the laser spot has disappeared (i.e., determination block 1312=“Yes”), at determination block 1314 the computing device may determine whether a flag has been set indicating that the computing device is waiting for an input. As described above, an input may be expected following certain laser gestures and may be in the form of another laser gesture traced on the projection surface. If a wait for input flag has not been set (i.e., determination block 1314=“No”), the computing device may analyze the path traced by the laser spot to characterize the laser spot movements at block 1316. As described above, this analysis may be accomplished by noting the tiles or regions of the projected content and/or camera field of view through which the laser spot traveled. In an aspect, this characterization may be reduced to the form of a code or summary description that can be used as a search criterion in a table look up process. At block 1318, the computing device may use the laser spot movement characterization to determine a function corresponding to the detected laser spot movement. As mentioned above, this process may involve a table look up process using the characterization of the laser spot movement as a search criterion. The process at block 1318 may further consider an application running on the computing device at the time, such as by using a data table of laser gestures suitable for the current application.

At determination block 1320, the computing device may determine whether the determined corresponding function involves an immediate action or requires an additional input. If the function does not require further input (i.e., determination block 1320=“No”), the computing device may implement the function, before returning to block 1306 to await detection of another laser spot within the field of view of the camera. If the determined function requires further input (i.e., determination block 1320=“Yes”), the computing device may set the wait for input flag at block 1322 before returning to block 1306 to await detection of another laser spot within the field of view of the camera. As part of block 1322, the computing device may also perform portions of the function, such as displaying a menu, displaying an icon or highlight indicating that an input is expected, or displaying a count down timer informing the user about the time or time before an input may be accepted.

Referring back to determination block 1314, if the computing device determines that the wait for input flag is set (i.e., determination block 1314=“Yes”), the computing device may treat the laser spot movement information as an input to the current application or to the function at block 1328. For example, if the determined function is to display a menu, the location of a laser spot within a menu item box may be accepted as an input selecting that menu item. As another example, if the determined function activated a draw application or function, the movement of the laser spot within the camera's field of view may be treated as a drawing input.

At block 1330, the application or function may process the received input and display the results in the projected image. Thus, if the input was a selection or drawing input, the projected image will include lines, circles or boxes reflecting the input indicated by the laser spot movements.

At determination block 1332, the computing device may determine whether the function or application expecting an input has completed such that no further inputs are expected. If the function has not completed and further inputs are expected (i.e., determination block 1332=“No”), the computing device may return to block 1306 to await detection of another laser spot within the field of view of the camera. If the computing device determines that the function has completed and further inputs are not expected (i.e., determination block 1332—“Yes”), the computing device may clear the wait for input flag at block 1334 before returning to block 1306 to await detection of another laser spot within the field of view of the camera.

Optionally, when the computing device determines that the wait for input flag is set (i.e., determination block 1314=“Yes”), the computing device may determine whether an action gesture is performed within a predetermined time “t” after the command gesture, at determination block 1326. If the action laser gesture is detected before the time “t” is expired (i.e., determination block 1326=“Yes”), the computing device may continue to block 1328 and 1330 by accepting the input and displaying the results of the input as described above. However, if a laser spot is not detected before the time “t” expires (i.e., determination block 1326=“No”), the computing device may clear the wait for input flag at block 1334 before returning to block 1306 to await detection of another laser spot within the field of view of the camera.

FIG. 13B illustrates a second aspect method 1350 for implementing a user interface accepting laser gestures detected by a camera coupled to a computing device in which the color of the laser spot is determined and used in conjunction with a detected laser gesture to determine a suitable function. The like numbered processes of method 1350 are similar to those described above with reference to FIG. 13A. Additionally, in method 1350 at block 1352, the computing device may recognize the detected color of the laser spot, such as by comparing the pixel intensity values of the different color components (e.g., red, green, blue) to one or more threshold values. Then, at block 1354, the computing device may use the recognized laser spot color in combination with the characterized laser spot motion to determine a corresponding function. As described above, this may be accomplished in a table look up process using a table that correlates functions to be implemented with laser spot motions and laser color. In this manner, twice as many different types of laser gestures may be recognized and implemented if users can shine lasers of two different colors (e.g., green and red).

FIG. 13C illustrates a third aspect method 1360 for implementing a user interface accepting laser gestures detected by a camera coupled to a computing device in which the color of the laser spot is determined and used to differentiate between function gestures and computer inputs. The like numbered processes of method 1360 are similar to those described above with reference to FIGS. 13A and 13C. Additionally, in method 1360 at determination block 1362, the computing device may determine how to process the laser spot based upon its color. If the laser spot color is recognized as red, for example, the computing device may process the laser spot movements to determine if it traces a laser gesture by executing processes at blocks 1308 through 1324 as described above with reference to FIG. 13A. If the computing device determines that the laser spot is green (i.e., determination block 1362=“Green”), for example, the computing device may laser spot locations and movements as inputs to an application (e.g., a drawing application) at block 1328. Such inputs may be provided to an application which updates the projected image to include the lines traced by the green laser spot at 1330. At determination block 1364, the computer device may monitor the camera image to determine whether the green laser spot remains visible in the camera field of view. If the laser spot is still visible (i.e., determination block 1364=“Yes”), the computing device will continue to treat the laser spot movements as inputs at block 1328. Once the laser spot disappears (i.e., determination block 1364=“No”), the computing device may return to block 1306 to await detection of another laser spot within the field of view of the camera. In this manner, users possessing two different color lasers (e.g., green and red) can use one color laser for pointing and entering laser gestures and the other color laser for entering drawing and highlighting lines to an application generating the projected image. The allocation of laser colors to particular types of user inputs in the description above and in FIG. 13C is arbitrary and for example purposes only, as laser gesture inputs may be indicated by a green laser while drawing inputs are indicated by a red laser (i.e., the branches of determination block 1362 may be reversed).

In a further aspect, the results of laser gestures and inputs on the projected image as maintained by the computing device may be communicated to other computing devices over a data communication network, such as a local area network, the Internet, and/or a wireless communication network. In this manner other co-workers not in the room with the computing device may participate in the collaboration session by viewing the projected image on their own computing device displays. Methods for communicating a computer image and sound over a data communication network, such as a local area network, the Internet, and/or a wireless communication network, are well known in the communication arts.

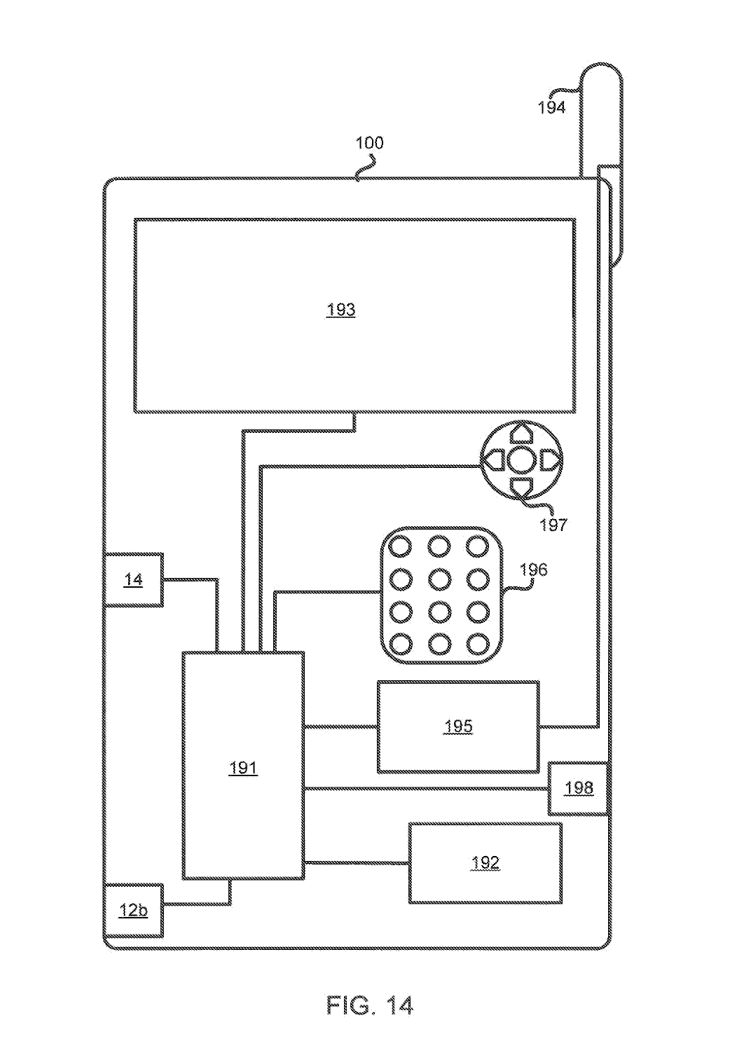

The aspects described above may be implemented on any of a variety of computing devices 1400. Typically, such computing devices 1400 will have in common the components illustrated in FIG. 14. The processor 191 may be any programmable microprocessor, microcomputer or multiple processor chip or chips that can be configured by software instructions (applications) to perform a variety of functions, including the functions of the various embodiments described herein. The processor may be coupled to memory 192, a display 193, and to a wireless transceiver 195 coupled to an antenna 194 for coupling the processor 191 to a wireless data network. Typically, software applications may be stored in the internal memory 192 before they are accessed and loaded into the processor 191. In some mobile devices, the processor 191 may include internal memory sufficient to store the application software instructions. In many mobile devices, the internal memory 192 may be a volatile or nonvolatile memory, such as flash memory, or a mixture of both. For the purposes of this description, a general reference to memory refers to all memory accessible by the processor 191, including internal memory 192, removable memory plugged into the mobile device, and memory within the processor 191 itself. The processor 191 may further be coupled to a projector 12b, such as a pico projector, and to a digital camera 14. The processor 191 may further be connected to a wired network interface 198, such as a universal serial bus (USB) or FireWire® connector socket, for connecting the processor 191 to external projectors 199 or cameras 1402, as well as to a wired data communication network.

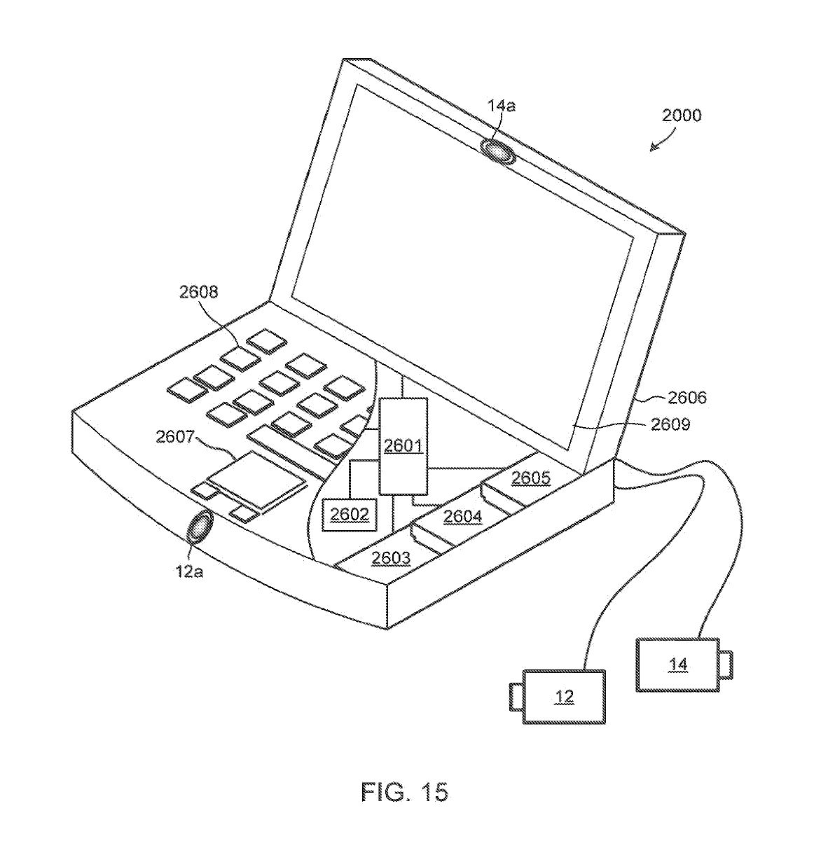

The aspects described above may also be implemented within a variety of computing devices, such as a laptop computer 2000 as illustrated in FIG. 15. A laptop computer 2000 will typically include a processor 2601 coupled to volatile memory 2602 and a large capacity nonvolatile memory, such as a disk drive 2603. The computer 2000 may also include a floppy disc drive 2604 and a compact disc (CD) drive 2605 coupled to the processor 2601. The computer device 2000 may also include a number of connector ports coupled to the processor 2601 for establishing data connections or receiving external memory devices, such as a USB or FireWire® connector sockets or other network connection circuits 2606 for coupling the processor 2601 to a data communication network. The computing device 2000 may be connected to or be equipped with an integrated digital camera 14a and an integrated projector 12a each connected to the processor 2601. Alternatively, the computing device 2000 may be coupled to an external projector 12 and an external digital camera 14 by a cable connection (e.g., a USB network). In a notebook configuration, the computer housing includes the touchpad 2607, keyboard 2608 and the display 2609 all coupled to the processor 2601.

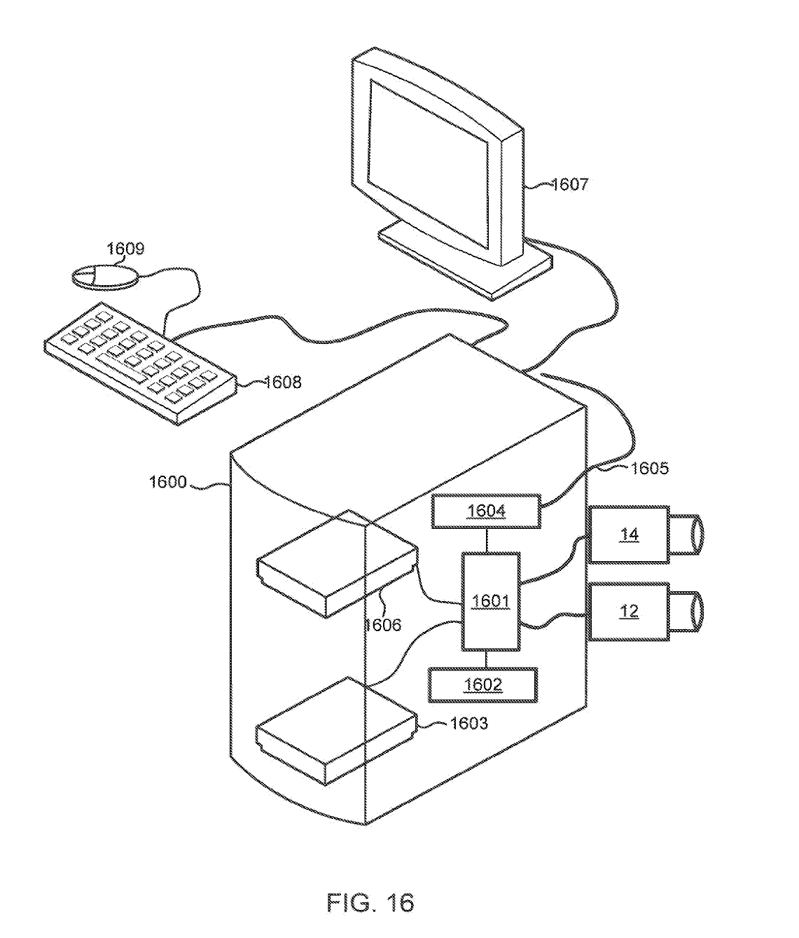

The aspects described above may also be implemented on any of a variety of computing devices, such as a personal computer 1600 illustrated in FIG. 16. Such a personal computer 1600 typically includes a processor 1601 coupled to volatile memory 1602 and a large capacity nonvolatile memory, such as a disk drive 1603. The computer 1610 may also include a floppy disc drive 1606 and a compact disc (CD) drive 1605 coupled to the processor 1601. The computer device 1600 may also include or be connected to a projector 12 and/or a digital camera 14. The computer device 1600 may also include a number of connector ports coupled to the processor 1601 for establishing data connections or receiving external memory devices, such as a network access circuit 1604 for connecting the processor 1601 to data communication network 1605, and USB and/or FireWire® connector sockets for coupling the processor to peripheral devices, such as an external projector 12, external camera 14.

The computing device processor 191, 2601, 1601 may be any programmable microprocessor, microcomputer or multiple processor chip or chips that can be configured by software instructions (applications) to perform a variety of functions, including the functions of the various aspects described above. In some portable computing devices 1400, 2000, 1600 multiple processors 191, 2601, 1601 may be provided, such as one processor dedicated to wireless communication functions and one processor dedicated to running other applications. The processor 191, 2601, 1601 may also be included as part of a communication chipset.

The foregoing method descriptions and the process flow diagrams are provided merely as illustrative examples and are not intended to require or imply that the processes of the various aspects must be performed in the order presented. As will be appreciated by one of skill in the art the order of blocks and processes in the foregoing aspects may be performed in any order. Words such as “thereafter,” “then,” “next,” etc. are not intended to limit the order of the processes; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm processes described in connection with the aspects disclosed herein may be implemented as electronic hardware, computer software, or combinations of both. To clearly illustrate this interchangeability of hardware and software, various illustrative components, blocks, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some processes or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The processes of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions stored on a machine readable medium and/or computer-readable medium, which may be incorporated into a computer program product.

The foregoing description of the various aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein, and instead the claims should be accorded the widest scope consistent with the principles and novel features disclosed herein.

What is claimed is:

1. A method for implementing a user interface function in a computing device coupled to a digital camera, comprising:
projecting an image generated by the computing device onto a surface;
viewing the projected image with the digital camera;
detecting locations of a laser spot within a field of view of the digital camera;
characterizing movement of the laser spot based on the location of the laser spot with respect to the projected image;
identifying a function correlated to the characterized laser spot movement; and
implementing the identified function on the computing device.

2. The method of claim 1, further comprising:
recognizing the projected image within the field of view of the digital camera; and
dividing the recognized digital image into tiles,
wherein characterizing movement of the laser spot is accomplished based upon movement of the laser spot from one tile to another.

3. The method of claim 1, wherein characterizing the laser beam reflection includes assigning a code to the movement of the laser spot.

4. The method of claim 1, wherein identifying a function associated with the laser beam reflection is based on the type of application running on the computing device.

5. The method of claim 1, wherein identifying a function associated with the laser spot comprises performing a table look up function using the characterized movement of the laser spot as a look up value for a data table of laser gestures and correlated functions.

6. The method of claim 1, wherein implementing the identified function on the computing device comprises detecting a subsequent laser spot within the field of view of the camera and treating a location or movement of the laser spot as an input to the computing device.

7. The method of claim 1, wherein identifying a function correlated to the characterized laser spot movement depends upon an application running on the computing device.

8. The method of claim 1, wherein identifying a function correlated to the characterized laser spot movement comprises recognizing a letter traced by the laser spot.

9. The method of claim 1, wherein:
identifying a function correlated to the characterized laser spot movement comprises identifying a menu of user interface options; and
implementing the identified function on the computing device comprises:
displaying the menu of user interface options within the projected image;
recognizing laser spot on a menu item box as a menu selection input; and
implementing a function associated with the menu selection input.

10. The method of claim 1, further comprising:
recognizing the projected image within the field of view of the digital camera as a content area;
dividing the content area into tiles; and
treating the portion of the field of view of the digital camera outside of the content area as a non-content area,
wherein characterizing movement of the laser spot is accomplished based upon a tile within the content area that the laser spot enters as it either moves from the non-content area into the content area or from within the content area to the non-content area.

11. The method of claim 10, wherein characterizing movement of the laser spot is accomplished further based upon whether the laser spot moves from the non-content area into the content area or from within the content area to the non-content area.

12. The method of claim 10, wherein characterizing movement of the laser spot is based upon whether the laser spot traces a path selected from the group comprising movement from a non-content area to a content area, movement from a content area to a non-content area, and movement from a non-content area to a content area followed by tracing a pattern in the content area followed by movement to the non-content area,

13. The method of claim 10, further comprising:
determining a color of the laser spot;
treating laser spots determined to be a first color as inputs to an application; and
including the inputs in the displayed image,
wherein characterizing movement of the laser spot based on the location of the laser spot with respect to the projected image is accomplished for laser spots determined to be a second color.

14. The method of claim 10, wherein detecting locations of a laser spot within a field of view of the digital camera comprises detecting locations of a plurality of laser spots within the field of view of the digital camera, the method further comprising:
determining a color of each of the plurality of detected laser spots;
determining a priority associated with each determined color of the laser spot; and
ignoring laser spots of lower priority,
wherein characterizing movement of the laser spot is performed for the laser spot with a highest priority.

15. The method of claim 10, further comprising correlating the projected image and the camera image received from the digital camera by performing one of:
recognizing boundaries of the projected image within the received camera image;
recognizing features of the projected image within the received camera image;
projecting a known pattern and recognizing a feature of the known pattern within the received camera image; and
tracking a path traced by a laser spot within the received camera image and treating an area within the received camera image outlined by the laser spot path as the content area and treating a remainder of the received camera image as the non-content area.

16. The method of claim 15, further comprising determining a portion of the projected image encircled by movement of the laser spot on the surface,
wherein implementing the identified function on the computing device comprises implementing the identified function on the determined portion of the projected image.

17. The method of claim 10, further comprising determining a color of the laser spot, wherein identifying a function correlated to the characterized laser spot movement comprises identifying a function correlated to the laser color and the characterized laser spot movement.

18. The method of claim 17, wherein identifying a function associated with the laser spot comprises performing a table look up function using the characterized movement of the laser spot and the determined laser color as look up values for a data table of laser gestures, laser colors and correlated functions.

19. The method of claim 17, further comprising communicating the projected image to another computing device via a network.

20. A system, comprising:
a processor;
a projector coupled to the processor and configured to project onto a surface an image generated by the processor; and
a digital camera coupled to the processor and configured to obtain a digital image of the surface,
wherein the processor is configured with processor executable instructions to perform operations comprising:
causing the projector to project onto the surface an image generated by the processor;
receiving from the digital camera a digital image of the projected image;
detecting locations of a laser spot within a field of view of the digital camera;
characterizing movement of the laser spot based on the location of the laser spot with respect to the projected image;
identifying a function correlated to the characterized laser spot movement; and
implementing the identified function on the computing device.

21. The system of claim 20, wherein the processor is configure to perform operations further comprising:
recognizing the projected image within the field of view of the digital camera; and
dividing the recognized digital image into tiles,
wherein the processor is configured such that characterizing movement of the laser spot is accomplished based upon movement of the laser spot from one tile to another.

22. The system of claim 20, wherein the processor is configured such that characterizing the laser beam reflection includes assigning a code to the movement of the laser spot.

23. The system of claim 20, wherein the processor is configured such that identifying a function associated with the laser beam reflection is based on the type of application running on the computing device.

24. The system of claim 20, wherein the processor is configured such that identifying a function associated with the laser spot comprises performing a table look up function using the characterized movement of the laser spot as a look up value for a data table of laser gestures and correlated functions.

25. The system of claim 20, wherein the processor is configured such that implementing the identified function on the computing device comprises detecting a subsequent laser spot within the field of view of the camera and treating a location or movement of the laser spot as an input to the computing device.

26. The system of claim 20, wherein the processor is configured such that identifying a function correlated to the characterized laser spot movement depends upon an application running on the computing device.

27. The system of claim 20, wherein the processor is configured such that identifying a function correlated to the characterized laser spot movement comprises recognizing a letter traced by the laser spot.

28. The system of claim 20, wherein the processor is configured such that:
identifying a function correlated to the characterized laser spot movement comprises identifying a menu of user interface options; and
implementing the identified function on the computing device comprises:
displaying the menu of user interface options within the projected image;
recognizing laser spot on a menu item box as a menu selection input; and
implementing a function associated with the menu selection input.

29. The system of claim 20, wherein the processor, the projector and the digital camera are incorporated within a single computing device.

30. The system of 29, wherein the single computing device is a mobile computing device.

31. The system of 29, wherein the single computing device is a personal computing device.

32. The system of claim 20, wherein the processor is configure to perform operations further comprising:
recognizing the projected image within the field of view of the digital camera as a content area;
dividing the content area into tiles; and
treating the portion of the field of view of the digital camera outside of the content area as a non-content area,
wherein the processor is configured such that characterizing movement of the laser spot is accomplished based upon a tile within the content area that the laser spot enters as it either moves from the non-content area into the content area or from within the content area to the non-content area.

33. The system of claim 32, wherein the processor is configured such that characterizing movement of the laser spot is accomplished further based upon whether the laser spot moves from the non-content area into the content area or from within the content area to the non-content area.

34. The system of claim 32, wherein the processor is configure to perform operations further comprising determining a color of the laser spot, wherein identifying a function correlated to the characterized laser spot movement comprises identifying a function correlated to the laser color and the characterized laser spot movement.

35. The system of claim 32, wherein the processor is configured such that detecting locations of a laser spot within a field of view of the digital camera comprises detecting locations of a plurality of laser spots within the field of view of the digital camera, and the wherein the processor is configured to perform operations further comprising:
determining a color of each of the plurality of detected laser spots;
determining a priority associated with each determined color of the laser spot; and
ignoring laser spots of lower priority,
wherein the processor is configured such that characterizing movement of the laser spot is performed for the laser spot with a highest priority.

36. The system of claim 32, wherein the processor is configure to perform operations further comprising:
determining a color of the laser spot;
treating laser spots determined to be a first color as inputs to an application; and
including the inputs in the displayed image,
wherein the processor is configured such that characterizing movement of the laser spot based on the location of the laser spot with respect to the projected image is accomplished for laser spots determined to be a second color.

37. The system of claim 36, wherein the processor is configure to perform operations further comprising communicating the projected image to another computing device via a network.

38. The system of claim 32, wherein the processor is configure such that characterizing movement of the laser spot is based upon whether the laser spot traces a path selected from the group comprising movement from a non-content area to a content area, movement from a content area to a non-content area, and movement from a non-content area to a content area followed by tracing a pattern in the content area followed by movement to the non-content area,

39. The system of claim 38, wherein the processor is configured such that identifying a function associated with the laser spot comprises performing a table look up function using the characterized movement of the laser spot and the determined laser color as look up values for a data table of laser gestures, laser colors and correlated functions.

40. The system of claim 32, wherein the processor is configure to perform operations further comprising correlating the projected image and the camera image received from the digital camera by performing one of:
recognizing boundaries of the projected image within the received camera image;
recognizing features of the projected image within the received camera image;
projecting a known pattern and recognizing a feature of the known pattern within the received camera image; and
tracking a path traced by a laser spot within the received camera image and treating an area within the received camera image outlined by the laser spot path as the content area and treating a remainder of the received camera image as the non-content area.

41. The system of claim 40, wherein the processor is configure to perform operations further comprising determining a portion of the projected image encircled by movement of the laser spot on the surface,
wherein the processor is configured such that implementing the identified function on the computing device comprises implementing the identified function on the determined portion of the projected image.

42. A computing system, comprising:
computing means for generating an image;
projector means for projecting an image generated by computing means onto a surface;
camera means for obtaining a digital image of the projected image;
means for detecting locations of a laser spot within a field of view of the camera means;
means for characterizing movement of the laser spot based on the location of the laser spot with respect to the projected image;
means for identifying a function correlated to the characterized laser spot movement; and
means for implementing the identified function on the computing means.

43. The computing system of claim 42, further comprising:
means for recognizing the projected image within the field of view of the camera means; and
means for dividing the recognized digital image into tiles,
wherein means for characterizing movement of the laser spot comprises means for characterizing movement of the laser spot based upon movement of the laser spot from one tile to another.

44. The computing system of claim 42, wherein means for characterizing the laser beam reflection includes means for assigning a code to the movement of the laser spot.

45. The computing system of claim 42, wherein means for identifying a function associated with the laser beam reflection comprises means for identifying a function associated with the laser beam reflection based on the type of application running on the computing device.

46. The computing system of claim 42, wherein means for identifying a function associated with the laser spot comprises means for performing a table look up function using the characterized movement of the laser spot as a look up value for a data table of laser gestures and correlated functions.

47. The computing system of claim 42, wherein means for implementing the identified function on the computing device comprises means for detecting a subsequent laser spot within the field of view of the camera and treating a location or movement of the laser spot as an input to the computing device.

48. The computing system of claim 42, wherein means for identifying a function correlated to the characterized laser spot movement comprises means for identifying a function correlated to the characterized laser spot movement depending upon an application running on the computing device.

49. The computing system of claim 42, wherein means for identifying a function correlated to the characterized laser spot movement comprises means for recognizing a letter traced by the laser spot.

50. The computing system of claim 42, wherein:
means for identifying a function correlated to the characterized laser spot movement comprises means for identifying a menu of user interface options; and
means for implementing the identified function on the computing device comprises:
means for displaying the menu of user interface options within the projected image;
means for recognizing laser spot on a menu item box as a menu selection input; and
means for implementing a function associated with the menu selection input.

51. The computing system of claim 48, further means for comprising communicating the projected image to another computing device via a network.

52. The computing system of claim 42, further comprising:
means for recognizing the projected image within the field of view of the digital camera as a content area;
means for dividing the content area into tiles; and
means for treating the portion of the field of view of the digital camera outside of the content area as a non-content area,
wherein means for characterizing movement of the laser spot comprises means for characterizing movement of the laser spot based upon a tile within the content area that the laser spot enters as it either moves from the non-content area into the content area or from within the content area to the non-content area.

53. The computing system of claim 52, wherein means for characterizing movement of the laser spot comprises means for characterizing movement of the laser spot based upon whether the laser spot moves from the non-content area into the content area or from within the content area to the non-content area.

54. The computing system of claim 52, further comprising means for determining a color of the laser spot, wherein means for identifying a function correlated to the characterized laser spot movement comprises means for identifying a function correlated to the laser color and the characterized laser spot movement.

55. The computing system of claim 52, further comprising:
means for determining a color of the laser spot;
means for treating laser spots determined to be a first color as inputs to an application; and
means for including the inputs in the displayed image,
wherein means for characterizing movement of the laser spot based on the location of the laser spot with respect to the projected image wherein means for characterizing movement of the laser spot based on the location of the laser spot with respect to the projected image for laser spots determined to be a second color.

56. The computing system of claim 52, wherein means for detecting locations of a laser spot within a field of view of the digital camera comprises means for detecting locations of a plurality of laser spots within the field of view of the digital camera, the computing system further comprising:
means for determining a color of each of the plurality of detected laser spots;
means for determining a priority associated with each determined color of the laser spot; and
means for ignoring laser spots of lower priority,
wherein characterizing movement of the laser spot is performed for the laser spot with a highest priority.

57. The computing system of claim 52, wherein means for characterizing movement of the laser spot comprises means for characterizing movement of the laser spot based upon whether the laser spot traces a path selected from the group comprising movement from a non-content area to a content area, movement from a content area to a non-content area, and movement from a non-content area to a content area followed by tracing a pattern in the content area followed by movement to the non-content area,

58. The computing system of claim 57, wherein means for identifying a function associated with the laser spot comprises means for performing a table look up function using the characterized movement of the laser spot and the determined laser color as look up values for a data table of laser gestures, laser colors and correlated functions.

59. The computing system of claim 52, further comprising means for correlating the projected image and the camera image received from the digital camera, wherein means for correlating the projected image and the camera image received from the digital camera comprises one of:
means for recognizing boundaries of the projected image within the received camera image;
means for recognizing features of the projected image within the received camera image;
means for projecting a known pattern and recognizing a feature of the known pattern within the received camera image; and
means for tracking a path traced by a laser spot within the received camera image and treating an area within the received camera image outlined by the laser spot path as the content area and treating a remainder of the received camera image as the non-content area.

60. The computing system of claim 59, further comprising means for determining a portion of the projected image encircled by movement of the laser spot on the surface,
wherein means for implementing the identified function on the computing device comprises means for implementing the identified function on the determined portion of the projected image.

61. A computer readable storage medium having stored thereon processor-executable instructions configured to cause a computer processor to perform operations comprising:
projecting an image generated by the computing onto a surface by a projector coupled to the processor;
viewing the projected image with a digital camera coupled to the processor;
detecting locations of a laser spot within a field of view of the digital camera;
characterizing movement of the laser spot based on the location of the laser spot with respect to the projected image;
identifying a function correlated to the characterized laser spot movement; and
implementing the identified function on the computing device.

62. The computer readable storage medium of claim 61, wherein the computer readable medium has stored there on processor-executable instructions configured to cause a processor to perform operations further comprising:
recognizing the projected image within the field of view of the digital camera; and
dividing the recognized digital image into tiles,
wherein characterizing movement of the laser spot is accomplished based upon movement of the laser spot from one tile to another.

63. The computer readable storage medium of claim 61, wherein the computer readable medium has stored there on processor-executable instructions configured to cause a processor to perform operations such that characterizing the laser beam reflection includes assigning a code to the movement of the laser spot.

64. The computer readable storage medium of claim 61, wherein the computer readable medium has stored there on processor-executable instructions configured to cause a processor to perform operations such that identifying a function associated with the laser beam reflection is based on the type of application running on the computing device.

65. The computer readable storage medium of claim 61, wherein the computer readable medium has stored there on processor-executable instructions configured to cause a processor to perform operations such that identifying a function associated with the laser spot comprises performing a table look up function using the characterized movement of the laser spot as a look up value for a data table of laser gestures and correlated functions.

66. The computer readable storage medium of claim 61, wherein the computer readable medium has stored there on processor-executable instructions configured to cause a processor to perform operations such that implementing the identified function on the computing device comprises detecting a subsequent laser spot within the field of view of the camera and treating a location or movement of the laser spot as an input to the computing device.

67. The computer readable storage medium of claim 61, wherein the computer readable medium has stored there on processor-executable instructions configured to cause a processor to perform operations such that identifying a function correlated to the characterized laser spot movement depends upon an application running on the computing device.

68. The computer readable storage medium of claim 61, wherein the computer readable medium has stored there on processor-executable instructions configured to cause a processor to perform operations such that identifying a function correlated to the characterized laser spot movement comprises recognizing a letter traced by the laser spot.

69. The computer readable storage medium of claim 61, wherein the computer readable medium has stored there on processor-executable instructions configured to cause a processor to perform operations such that:
identifying a function correlated to the characterized laser spot movement comprises identifying a menu of user interface options; and
implementing the identified function on the computing device comprises:
displaying the menu of user interface options within the projected image;
recognizing laser spot on a menu item box as a menu selection input; and
implementing a function associated with the menu selection input.

70. The computer readable storage medium of claim 61, wherein the computer readable medium has stored there on processor-executable instructions configured to cause a processor to perform operations further comprising:
recognizing the projected image within the field of view of the digital camera as a content area;
dividing the content area into tiles; and
treating the portion of the field of view of the digital camera outside of the content area as a non-content area,
wherein characterizing movement of the laser spot is accomplished based upon a tile within the content area that the laser spot enters as it either moves from the non-content area into the content area or from within the content area to the non-content area.

71. The computer readable storage medium of claim 70, wherein the computer readable medium has stored there on processor-executable instructions configured to cause a processor to perform operations such that characterizing movement of the laser spot is accomplished further based upon whether the laser spot moves from the non-content area into the content area or from within the content area to the non-content area.

72. The computer readable storage medium of claim 70, wherein the computer readable medium has stored there on processor-executable instructions configured to cause a processor to perform operations such that characterizing movement of the laser spot is based upon whether the laser spot traces a path selected from the group comprising movement from a non-content area to a content area, movement from a content area to a non-content area, and movement from a non-content area to a content area followed by tracing a pattern in the content area followed by movement to the non-content area,

73. The computer readable storage medium of claim 70, wherein the computer readable medium has stored there on processor-executable instructions configured to cause a processor to perform operations such that detecting locations of a laser spot within a field of view of the digital camera comprises detecting locations of a plurality of laser spots within the field of view of the digital camera,
wherein the computer readable medium has stored there on processor-executable instruction configured to cause a processor to perform operations further comprising:
determining a color of each of the plurality of detected laser spots;
determining a priority associated with each determined color of the laser spot; and
ignoring laser spots of lower priority,
wherein characterizing movement of the laser spot is performed for the laser spot with a highest priority.

74. The computer readable storage medium of claim 70, wherein the computer readable medium has stored there on processor-executable instructions configured to cause a processor to perform operations further comprising determining a color of the laser spot, wherein identifying a function correlated to the characterized laser spot movement comprises identifying a function correlated to the laser color and the characterized laser spot movement.

75. The computer readable storage medium of claim 74, wherein the computer readable medium has stored there on processor-executable instructions configured to cause a processor to perform operations such that identifying a function associated with the laser spot comprises performing a table look up function using the characterized movement of the laser spot and the determined laser color as look up values for a data table of laser gestures, laser colors and correlated functions.

76. The computer readable storage medium of claim 70, wherein the computer readable medium has stored there on processor-executable instructions configured to cause a processor to perform operations further comprising:
determining a color of the laser spot;
treating laser spots determined to be a first color as inputs to an application; and
including the inputs in the displayed image,
wherein characterizing movement of the laser spot based on the location of the laser spot with respect to the projected image is accomplished for laser spots determined to be a second color.

77. The computer readable storage medium of claim 76, wherein the computer readable medium has stored there on processor-executable instructions configured to cause a processor to perform operations further comprising communicating the projected image to another computing device via a network.

78. The computer readable storage medium of claim 70, wherein the computer readable medium has stored there on processor-executable instructions configured to cause a processor to perform operations further comprising correlating the projected image and the camera image received from the digital camera by performing one of:
recognizing boundaries of the projected image within the received camera image;
recognizing features of the projected image within the received camera image;
projecting a known pattern and recognizing a feature of the known pattern within the received camera image; and
tracking a path traced by a laser spot within the received camera image and treating an area within the received camera image outlined by the laser spot path as the content area and treating a remainder of the received camera image as the non-content area.

79. The computer readable storage medium of claim 78, wherein the computer readable medium has stored there on processor-executable instructions configured to cause a processor to perform operations further comprising determining a portion of the projected image encircled by movement of the laser spot on the surface,
wherein implementing the identified function on the computing device comprises implementing the identified function on the determined portion of the projected image.
